(19) United States
(12) Patent Application Publication
(10) Pub. No.: US 2008/0100861 A1
(43) Pub. Date: May 1, 2008

(54) Image processing apparatus, image processing method, and storage medium

(75) Inventor: Masayuki Sakura, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/812,537

(22) Filed: Jun. 20, 2007

(30) Foreign Application Priority Data
Oct. 26, 2006 (JP) 2006-291716

(51) Int. Cl. G06F 3/12

(52) U.S. Cl. 358/1.15

(57) ABSTRACT

In an image processing apparatus having the first storage medium which saves data transmitted from an external apparatus, when it is determined that no new data can be saved in the first storage medium, selected data is stored in the second removable storage medium. Then, the selected data is deleted from the first storage medium while information capable of identifying the selected data is left in it.

### BACKGROUND OF THE INVENTION

1. Field of the Invention

The present invention relates to an image processing apparatus, image processing method, and storage medium and, more particularly, to a data save technique used when, for example, data stored in an image processing apparatus is saved in an external storage medium.

2. Description of the Related Art

Conventionally, the following process is executed when the free space of the memory box area runs short in saving data in a storage medium.

For example, if it is determined that the memory box of an image server does not have a free area, an old image stored in the memory box is selected and saved in the storage medium of a host computer communicable with the image server, ensuring a free space in the memory box area. Japanese Patent Laid-Open No. 11-275326 proposes this technique.

Japanese Patent Laid-Open No. 05-212917 proposes the following process in a system built by connecting a client computer having a printer driver to a digital copying apparatus capable of saving documents.

When the ratio of print data occupying the memory of the digital copying apparatus exceeds a predetermined value, data of the oldest use log is compressed and saved in an unused memory area. To use compressed data, it is decompressed. When the memory which saves data in the digital copying apparatus overflows, data of the oldest use log is erased except for its attribute information, ensuring a free memory area. Then, the contents of the attribute information of the erased data are displayed.

The technique disclosed in Japanese Patent Laid-Open No. 11-275326 saves old data in a communicable host computer when the storage capacity of the memory box runs short. If the storage medium of the communicable host computer runs out of the free area, no data can be backed up.

Capacity shortage of the storage medium of the host computer can be canceled by connecting a new host computer, which, however, raises cost.

The technique disclosed in Japanese Patent Laid-Open No. 05-212917 backs up print data in a free memory in the printer when the print data save area runs short. If the printer memory becomes full, no print data can be backed up. When the memory overflows, actual data of data of the oldest use log is erased though attribute information of the data remains. It is cumbersome to utilize the actual data again.

### SUMMARY OF THE INVENTION

The present invention provides an image processing apparatus, image processing method, and storage medium for prompting the user to mount a removable storage medium, reading out print-designated data from the removable medium, and printing it when the user designates printing of data saved in the removable storage medium.

According to one aspect of the present invention, an image processing apparatus includes a first storage medium configured to save data transmitted from an external apparatus, a monitor unit configured to monitor a free capacity of the first storage medium, a storage control unit configured to, when the monitor unit determines that no new data can be saved, store selected data in a removable second storage medium, leave, in the first storage medium, identifiable information capable of identifying the selected data, and delete the selected data from the first storage medium, a display control unit configured to display a selection window containing the identifiable information so as to accept selection of data to be printed, a selection unit configured to select the data to be printed that is designated via the selection window displayed by the display control unit, a notification unit configured to notify a user to mount the removable second storage medium when the data to be printed that is selected by the selection unit is stored in the removable second storage medium by the storage control unit, and a print control unit configured to control to print the data to be printed that is selected by the selection unit according to mounting the removable second storage medium notified by the notification unit.

According to another aspect of the present invention, an image processing apparatus includes a determination unit configured to determine whether a function of the image processing apparatus can process selected data, by comparing information about a function which is provided by the image processing apparatus and can process data, with information about a function necessary to process the selected data that is read from a removable second storage medium storing the selected data and the information about the function, and a processing unit configured to, when the determination unit determines that the function of the image processing apparatus can process the selected data, process the selected data read out from the removable second storage medium.

According to still another aspect of the present invention, an image processing apparatus includes a first storage medium configured to save data transmitted from an external apparatus, an instruction input unit configured to designate and input data to be stored in a removable second storage medium in accordance with an instruction from a user, a storage control unit configured to leave, in the first storage medium, identifiable information capable of identifying data designated by the instruction input unit, and delete the designated data from the first storage medium, a display control unit configured to display a selection window containing the identifiable information so as to accept selection of data to be printed, a selection unit configured to select the data to be printed that is designated via the selection window displayed by the display control unit, a notification unit configured to notify the user to mount the removable second storage medium when the data to be printed that is selected by the selection unit is stored in the removable second storage medium by the storage control unit, and a print control unit configured to control to print the data to be printed that is selected by the selection unit according to mounting the removable second storage medium notified by the notification unit.

According to yet another aspect of the present invention, an image processing method for an image processing apparatus having a first storage medium which saves data transmitted from an external apparatus, the image processing method includes a monitor step of monitoring a free capacity of the first storage medium, a storage control step of, when no new data is determined in the monitor step to be saved, storing selected data in a removable second storage medium, leaving, in the first storage medium, identifiable information capable of identifying the selected data, and deleting the selected data from the first storage medium, a display control step of displaying a selection window containing the identifiable information so as to accept selection of data to be printed, a selection step of selecting the data to be printed that is designated via the selection window displayed in the display control step, a notification step of notifying a user to mount the removable second storage medium when the data to be printed that is selected in the selection step is stored in the removable second storage medium in the storage control step, and a print control step of controlling to print the data to be printed that is selected in the selection step according to mounting the removable second storage medium notified in the notification step.

According to still yet another aspect of the present invention, an image processing method includes a determination step of determining whether a function of an image processing apparatus can process selected data, by comparing information about a function which is provided by the image processing apparatus and can process data, with information about a function necessary to process the selected data that is read from a removable second storage medium storing the selected data and the information about the function, and a processing step of, when the function of the image processing apparatus is determined in the determination step to be able to process the selected data, processing the selected data read out from the removable second storage medium.

According to yet still another aspect of the present invention, an image processing method for an image processing apparatus having a first storage medium which saves data transmitted from an external apparatus, the image processing method includes an instruction input step of designating and inputting data to be stored in a removable second storage medium in accordance with an instruction from a user, a storage control step of leaving, in the first storage medium, identifiable information capable of identifying data designated in the instruction input step, and deleting the designated data from the first storage medium, a display control step of displaying a selection window containing the identifiable information so as to accept selection of data to be printed, a selection step of selecting the data to be printed that is designated via the selection window displayed in the display control step, a notification step of notifying the user to mount the removable second storage medium when the data to be printed that is selected in the selection step is stored in the removable second storage medium in the storage control step, and a print control step of controlling to print the data to be printed that is selected in the selection step according to mounting the removable second storage medium notified in the notification step.

According to still yet another aspect of the present invention, a storage medium storing, in a computer-readable form, a program that realizes an image processing method for an image processing apparatus having a first storage medium which saves data transmitted from an external apparatus, wherein the program causes a computer to execute a monitor step of monitoring a free capacity of the first storage medium, a storage control step of, when no new data is determined in the monitor step to be saved, storing selected data in a removable second storage medium, leaving, in the first storage medium, identifiable information capable of identifying the selected data, and deleting the selected data from the first storage medium, a display control step of displaying a selection window containing the identifiable information so as to accept selection of data to be printed, a selection step of selecting the data to be printed that is designated via the selection window displayed in the display control step, a notification step of notifying a user to mount the removable second storage medium when the data to be printed that is selected in the selection step is stored in the removable second storage medium in the storage control step, and a print control step of controlling to print the data to be printed that is selected in the selection step according to mounting the removable second storage medium notified in the notification step.

According to yet still another aspect of the present invention, a storage medium storing, in a computer-readable form, a program that realizes an image processing method, wherein the program causes a computer to execute a determination step of determining whether a function of an image processing apparatus can process selected data, by comparing information on a function which is provided by the image processing apparatus and can process data, with information on a function necessary to process the selected data that is read from a removable second storage medium storing the selected data and the information on the function, and a processing step of, when the function of the image processing apparatus is determined in the determination step to be able to process the selected data, processing the selected data read out from the removable second storage medium.

According to still yet another aspect of the present invention, a storage medium storing, in a computer-readable form, a program that realizes an image processing method for an image processing apparatus having a first storage medium which saves data transmitted from an external apparatus, wherein the program causes a computer to execute an instruction input step of designating and inputting data to be stored in a removable second storage medium in accordance with an instruction from a user, a storage control step of leaving, in the first storage medium, identifiable information capable of identifying data designated in the instruction input step, and deleting the designated data from the first storage medium, a display control step of displaying a selection window containing the identifiable information so as to accept selection of data to be printed, a selection step of selecting the data to be printed that is designated via the selection window displayed in the display control step, a notification step of notifying the user to mount the removable second storage medium when the data to be printed that is selected in the selection step is stored in the removable second storage medium in the storage control step, and a print control step of controlling to print the data to be printed that is selected in the selection step according to mounting the removable second storage medium notified in the notification step.

Further features of the present invention will become apparent from the following description of exemplary embodiments with reference to the attached drawings.

### BRIEF DESCRIPTION OF THE DRAWINGS

FIG. 1 is a view showing a configuration of a printing system according to a present embodiment.

FIG. 2 is a block diagram showing a configuration of software installed in a client computer.

FIG. 3 is a flowchart showing print attribute setting process procedures by the client computer.

FIG. 4 is a view showing a display of the property sheet of a printer driver.

FIG. 5 is a view showing a display of the page setup sheet of the printer driver.

FIG. 6 is a view showing a display of a print instruction in the finishing sheet of the printer driver.

FIG. 7 is a flowchart showing print instruction process procedures by the client computer.

FIG. 8 is a flowchart showing document save process procedures by the client computer.

FIG. 9 is a view showing a display of a save instruction in the finishing sheet of the printer driver.

FIG. 10 is a view showing a display of a save destination designation dialog in saving document data.

FIG. 11 is a view showing a format of part of data to be printed containing Mail Box.

FIG. 12 is a block diagram showing a hardware configuration of a printer.

FIG. 13 is a flowchart schematically showing process procedures by the printer.

FIG. 14 is a view showing an exemplary remaining capacity shortage message displayed in the operation window of the printer.

FIG. 15 is a flowchart showing normal process procedures to print saved document data by the printer.

FIG. 16 is a view showing an exemplary document data save sheet displayed in the operation window of the printer.

FIGS. 17A and 17B are flowcharts showing process procedures to back up, in a removable medium, document data saved in the printer.

FIG. 18 is a view showing a display of notifying the user of shortage of the remaining capacity in the operation window of the printer.

FIG. 19 is a view showing an exemplary message displayed in the operation window of the printer to notify the user of shortage of the remaining capacity.

FIG. 20 is a view showing an exemplary message which notifies the user of output of a label by the printer for an external removable medium.

FIG. 21 is a view showing a label associated with an external removable medium according to the first embodiment.

FIG. 22 is a table showing a structure of a saved-data management table according to the first embodiment.

FIG. 23 is a view showing an exemplary list of saved document data displayed in the operation window of the printer according to the first embodiment.

FIG. 24 is a flowchart showing exemplary process procedures to print document data saved in an external removable medium according to the first embodiment.

FIG. 25 is a view showing an exemplary message displayed in the operation window of the printer to prompt the user to prepare an external removable medium according to the first embodiment.

FIG. 26 is a table showing a structure of a saved-data management table according to the second embodiment.

FIG. 27 is a view showing a label associated with an external removable medium according to the second embodiment.

FIGS. 28A and 28B are flowcharts showing exemplary process procedures to print document data saved in an external removable medium according to the second embodiment.

FIG. 29 is a view showing an exemplary list of saved document data displayed in the operation window of the printer according to the second embodiment.

FIG. 30 is a view showing an exemplary message which requests permission to print document data saved in an external removable medium by the printer according to the second embodiment.

FIG. 31 is a view showing a structure of document data saved in the save area of the printer according to the embodiment.

FIG. 32 is a block diagram showing an example of the functional blocks of the printer according to the embodiment.

FIG. 33 is a block diagram showing another example of the functional blocks of the printer according to the embodiment.

FIG. 34 is a block diagram showing still another example of the functional blocks of the printer according to the embodiment.

### DESCRIPTION OF THE EMBODIMENTS

Preferred embodiments of the present invention will be described below with reference to the accompanying drawings.

In the embodiments, a printing system according to the present invention will be explained by exemplifying the storage medium of a printer for saving data as an external storage medium, and as an external removable storage medium, a removable storage medium for backing up data saved in the storage medium of the printer. The embodiments are merely examples of the printing system according to the present invention. For example, the external storage medium may be a storage medium connected to a client computer locally or via a network in order to save data. The external removable storage medium may be a removable storage medium connected to an apparatus having a data save storage medium, or a removable storage medium locally connected to a client computer. The present invention also includes such storage media as long as the present invention is applicable to their relationship.

### Exemplary Configuration of Printing System According to Embodiment

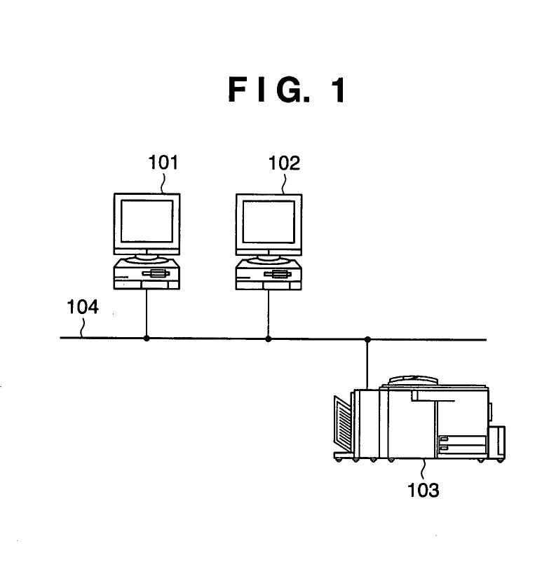

FIG. 1 is a view showing a configuration of a printing system according to a present embodiment.

As shown in FIG. 1, the printing system according to the present embodiment includes a client computer (client PC) 101, client computer (client PC) 102, and printer 103. The client PC 101, client PC 102, and printer 103 can communicate with each other via a network 104. FIG. 1 shows the two client PCs 101 and 102 in order to represent that a plurality of client PCs exist on the network 104. The two client PCs 101 and 102 basically have the same arrangement, so only the client PC 101 will be used for a description.

The client PC 101 has several applications for creating a document and the like, and a printer driver for outputting application data to the printer 103.

### Exemplary Arrangement of Client PC According to Embodiment

The hardware configuration of the client PC 101 according to the present embodiment is the same as that of a general-purpose PC, and a description thereof will be omitted.

### (Exemplary Software Configuration)

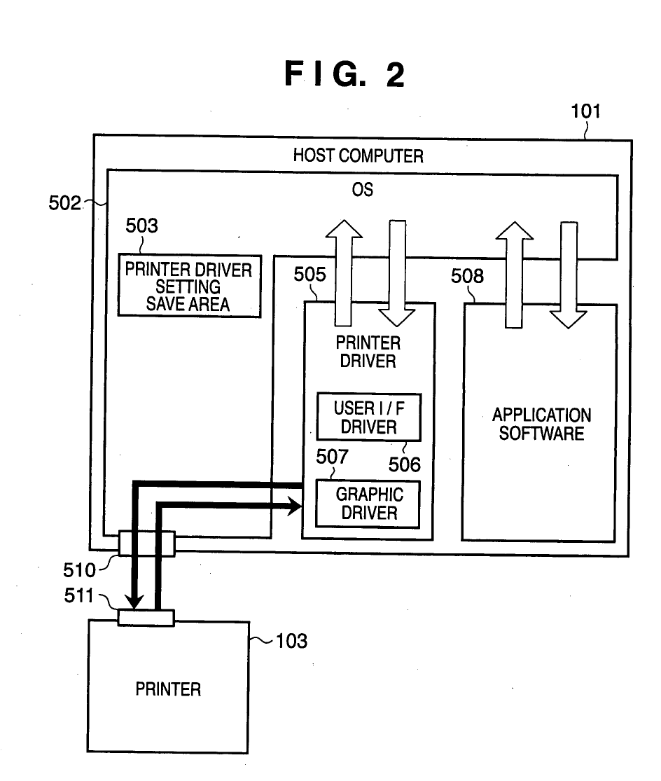

FIG. 2 is a block diagram showing a software configuration of the client PC 101 including the printer driver.

The client PC 101 has an operating system (OS) 502. A printer driver 505 and application software 508 are installed on the OS 502 and controlled by it.

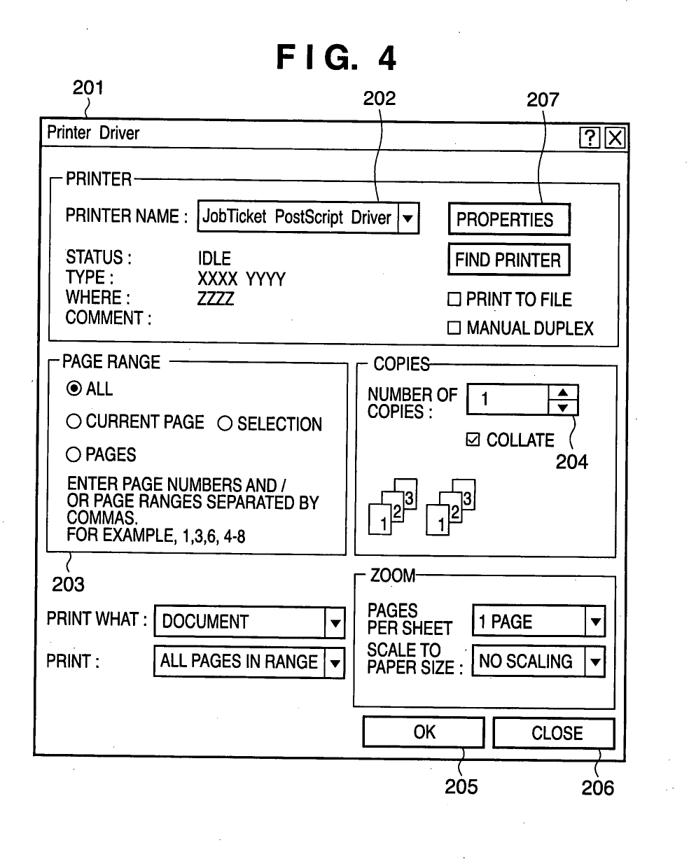

The printer driver 505 includes a user I/F driver 506 and graphic driver 507. The user I/F driver 506 displays a user I/F and saves settings. The graphic driver 507 converts a print rendering instruction issued from the application software 508 via the OS 502 into a code (PDL: Printer Description Language) interpretable by the printer 103. The user I/F driver 506 displays setup windows (print setup dialog and property sheet) as shown in FIGS. 4 to 6 when the application software 508 designates print settings via the OS 502.

A printer driver setting save area 503 exists in a save area managed by the OS 502, and saves print attributes set by the user via the user I/F driver 506. The user I/F driver 506, graphic driver 507, and application software 508 can access the printer driver setting save area 503 via the OS 502 to read print attributes set by the user.

A communication I/F 510 of the client PC 101 and a communication I/F 511 of the printer connect to each other via a communication medium such as a network. The graphic driver 507 can transmit a print job to the printer 103 via the OS 502. Also, the graphic driver 507 can obtain the configuration information and status of the printer 103 and the like via the OS 502.

### Exemplary Operation of Client PC According to Embodiment

The printer driver 505 provides a GUI of a display screen structure suitable to designate an output operation such as a print operation in the printer 103 of the printing system according to the present embodiment. The user can set desired parameters (printout process condition data) via the GUI. The GUI is a print setting GUI displayed on the display of a computer when the user designates printing via the operation window of an application or the like. In particular, the GUI is displayed on the display when the user designates display of “printer” properties by a key operation. The printer driver 505 controls to transmit user settings together with desired image data via a communication medium such as a network to a transmission destination (also called an output destination) such as the printer 103.

### (Exemplary Print Attribute Setting Procedures)

Procedures when the user selects a print setup menu from the menu of the application software 508 and sets print attributes on the printer driver 505 will be explained.

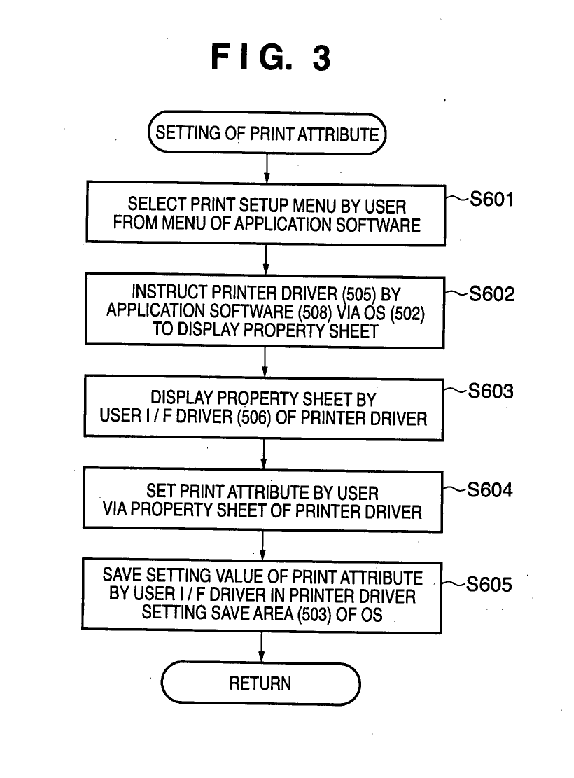

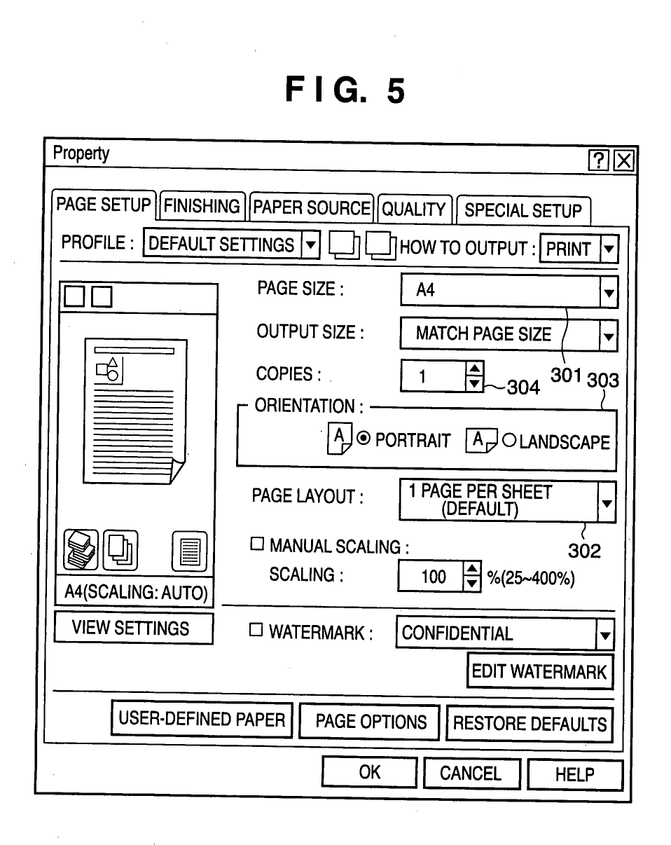

FIG. 3 is a flowchart showing operation procedures by the client PC 101 when the user designates printing. In step S601, the user selects the print setup menu from the menu of the application software 508. Then, the OS 502 displays an operation window shown in FIG. 4. If the user designates a property key 207 in the operation window shown in FIG. 4, the application software 508 calls the API of the OS 502, and instructs the printer driver 505 to display a print attribute setup property sheet in step S602. The API stands for Application Programming Interface, which will be abbreviated as API in this specification. In step S603, upon receiving the instruction via the OS 502 to display the print attribute setup property sheet by the printer driver 505, the user I/F driver 506 of the printer driver 505 displays the print attribute setup property sheet shown in FIG. 5. In step S604, the user sets print attributes via the print attribute setup property sheet of the printer driver 505. In other words, the client PC 101 sets print attributes in accordance with values input via the print attribute setup property sheet.

### (Exemplary Operation Window Associated with Settings of Print Attributes)

In FIG. 4, the OS 502 displays an operation window 201. A transmission destination selection column 202 is used to select the output destination of a print job. The user can select a desired output destination (printer) via the selection column 202 displayed in the operation window 201. When the user selects the property key 207, a printer driver corresponding to a printer selected via the selection column 202 is invoked.

A page setting control 203 is used to select the print range. The user decides the print range (i.e., pages to be output) of an image created by application software via the page setting control 203.

A copy count setting control 204 is used to designate the number of copies to be printed (output) by a device such as a printer in the printing system according to the present embodiment. The number of copies can be increased/decreased by clicking arrows (arrows of the scroll bar) of the copy count setting control 204. The property key 207 is used to make advanced settings related to a printer selected via the selection column 202.

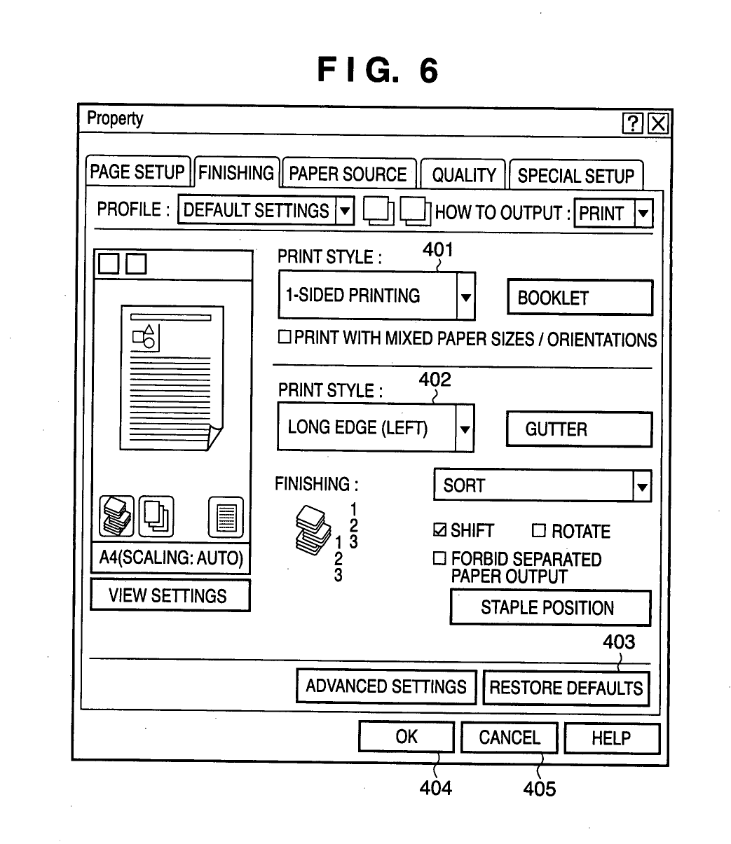

When the user selects the property key 207, the client PC 101 controls to display setup windows including various print setup property sheets shown in FIGS. 5 and 6 on the display. The user sets desired print attributes via various operation windows in FIGS. 4 to 6, and selects an OK key 205. Then, the printer driver 505 generates a print job complying with the desired print attributes set by the user, and transmits it. If the user selects a close key 206, the OS 502 ends the display of the operation window 201 without generating any print job.

The operation windows shown in FIGS. 5 and 6 will be explained.

The windows shown in FIGS. 5 and 6 have tab keys such as “page setup”, “finishing”, “paper source”, and “quality”. By clicking these tab keys, the user can set different detailed printout conditions such as “page setup” settings, “finishing” settings, “paper source” settings, and “quality” settings. The user clicks a tab key via an operation unit such as the pointing device (not shown) of the client PC 101.

FIG. 5 is a view showing an operation window displayed when the user selects the “page setup” tab key.

The operation window shown in FIG. 5 has a paper size setting column 301 capable of setting the size of print paper. The operation window shown in FIG. 5 has a page layout setting column 302 for setting a page layout. The user can select, via the page layout setting column 302, the number of pages (i.e., layout mode) of document image data to be laid out (formed) on the same surface of one print sheet. The operation window shown in FIG. 5 has an orientation setting column 303 used when the user selects a desired print orientation from a plurality of selection candidates such as portrait and landscape. The operation window shown in FIG. 5 has a copy count setting column 304 for setting the number of copies.

FIG. 6 is a view showing an operation window displayed when the user selects the “finishing” tab key.

The operation window shown in FIG. 6 has a plurality of setting columns used when the user sets setting information unique to a printer selected by the user via the operation window shown in FIG. 4. The operation window shown in FIG. 6 enables various advanced settings. The advanced settings include finishing settings such as a stapling setting, sorting setting, punching setting, and bookbinding setting. The operation window shown in FIG. 6 also enables various advanced settings such as a single- or double-side printing setting, and finer image process-related adjustment settings to change parameters such as color tincture by the printer.

For example, the operation window shown in FIG. 6 has a setting column 401 for setting single- or double-side printing. The printer driver 505 generates a print job in accordance with a print mode (i.e., single- or double-side printing) set by the user via the setting column 401. The operation window shown in FIG. 6 has a setting column 402 for setting the binding location (long- or short-edge binding) of print paper. The printer driver 505 generates a print job in accordance with the binding location (long-edge binding in the embodiment) of print paper set by the user via the setting column 402. The operation window shown in FIG. 6 has a restore key 403 to restore advanced settings in the operation window shown in FIG. 6 to default values by the printer driver 505.

The operation window shown in FIG. 6 has an OK key 404 to validate values set via the operation window shown in FIG. 6 and return to the operation window shown in FIG. 4, and a cancel key 405 to invalidate values set via the operation window shown in FIG. 6.

Although not shown, the user can set a paper source stage and the like by selecting the “paper source” tab key, and set a resolution, halftone, and the like by selecting the “quality” tab key.

In this manner, the user sets desired print process conditions (print attributes) via the operation windows shown in FIGS. 4 to 6. The printer driver 505 generates a print job based on a print rendering instruction aiming at printing, and the settings of print process conditions (setting values of print attributes). The printer driver 505 transmits the print job to the printer. The printer prints based on the print process conditions set by the user.

Referring back to FIG. 3, after setting print attributes, the user selects the OK key 205 in the operation window shown in FIG. 4 to decide the set print attributes in step S604. In step S605, upon receiving the selection with the OK key 205, the user I/F driver 506 calls the API of the OS 502, and saves the setting values of the print attributes set by the user in the printer driver setting save area 503. As a result, setting of print attributes and save of their setting values are complete.

### (Exemplary Print Process Procedures)

The sequence till printing after the user designates printing will be explained.

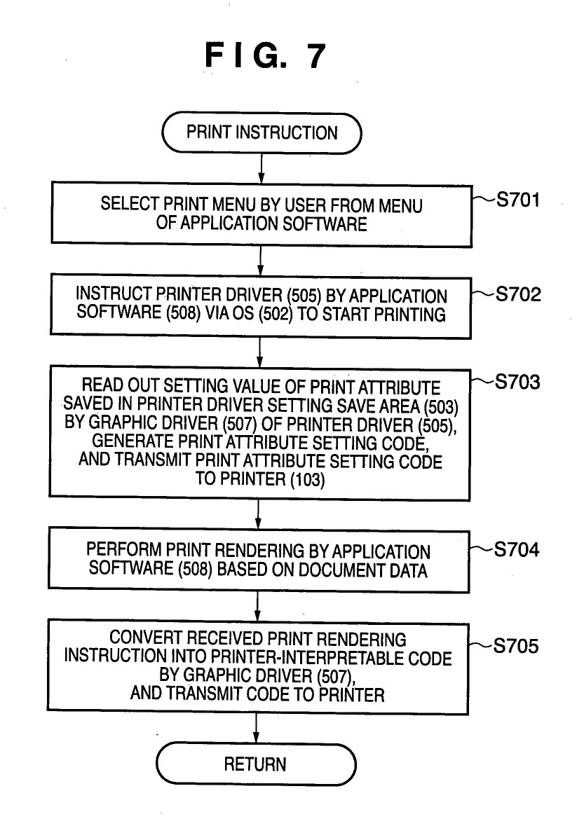

FIG. 7 is a flowchart showing operation procedures by the client PC 101 till printing after the user designates printing.

In step S701, the user selects a print menu from the menu of the application software 508. In step S702, the application software 508 calls the API of the OS 502, and instructs the printer driver 505 to start printing. During this process, the operation window (print setup dialog) shown in FIG. 4 may be displayed.

Upon receiving the print start instruction in step S702, the OS 502 instructs the printer driver 505 to start printing. In step S703, the graphic driver 507 of the printer driver 505 reads out the setting values of print attributes saved in the printer driver setting save area 503 of the OS 502 in accordance with the print start instruction. Further, the graphic driver 507 generates a print attribute setting code directed to the printer 103 based on the setting values of the print attributes, and transmits the code to the printer 103.

In step S704, the application software 508 performs print rendering via the OS 502 based on document data generated by the application software 508. In step S705, the graphic driver 507 is instructed to perform print rendering designated via the OS 502. The graphic driver 507 converts the received print rendering instruction into a print code interpretable by the printer 103, and transmits it to the printer 103. In other words, the printer driver 505 generates a print code interpretable by the printer 103 based on the setting values of the print attributes and the print rendering instruction.

The printer 103 performs rendering and prints based on the print code received from the graphic driver 507.

By the above-described procedures, printing can be executed based on print attributes set by the user.

### (Exemplary Document Data Save Process Procedures)

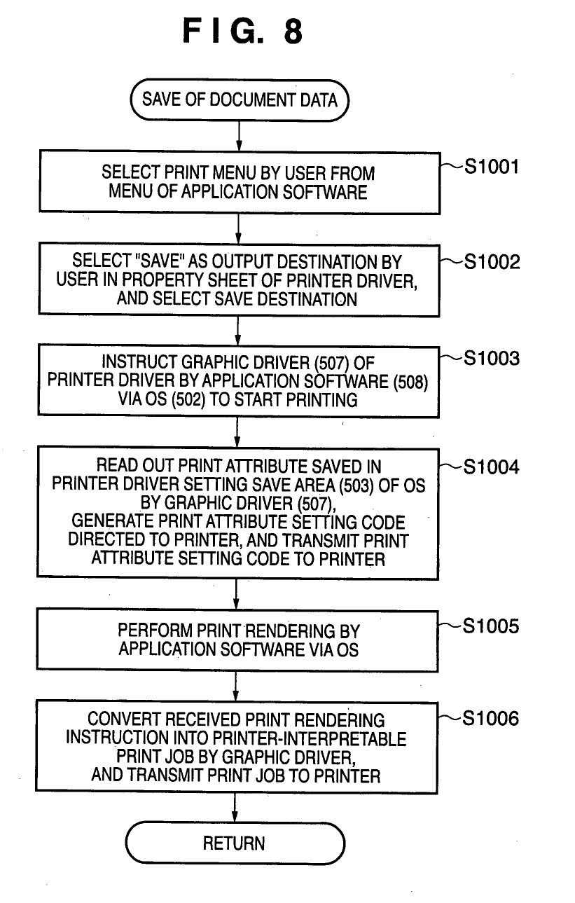

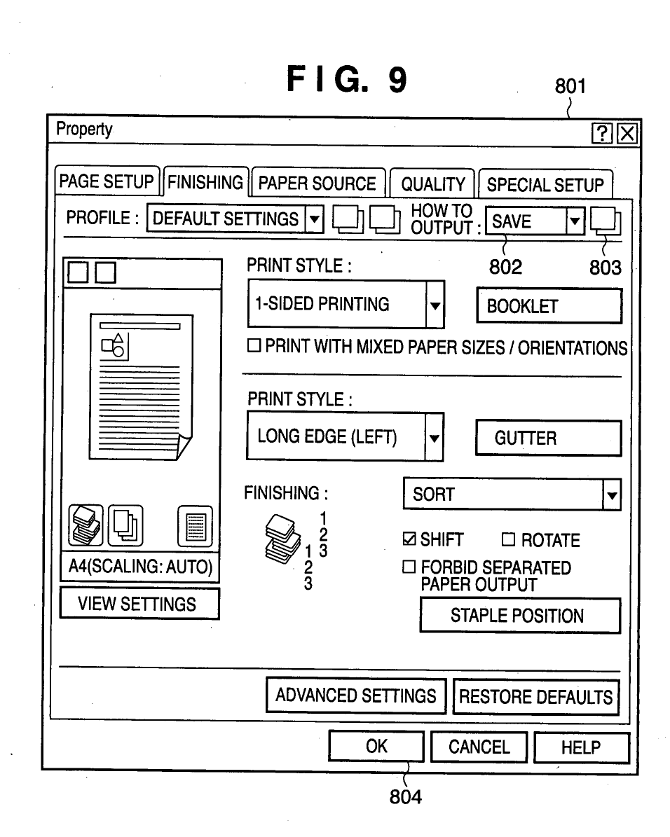

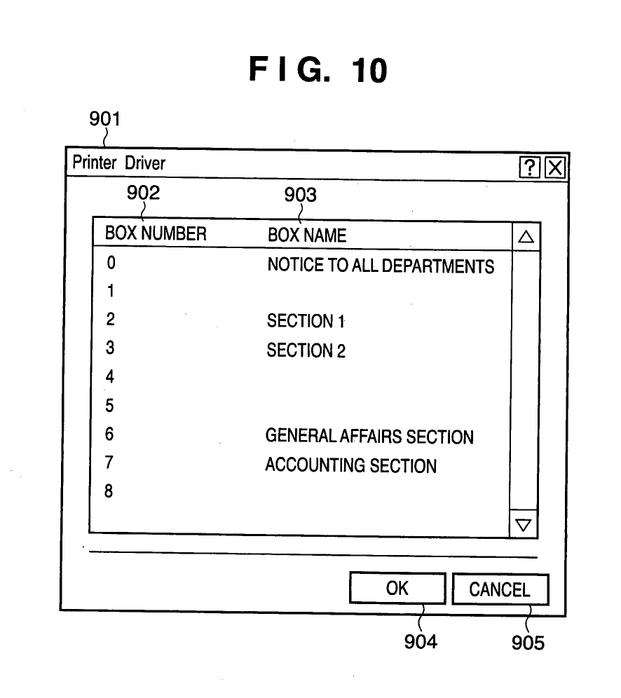

The sequence to save document data in the printer 103 from the client PC 101 via the printer driver 505 will be explained. In this specification, document data to be held is data based on a received print job. The print job itself may be saved. FIGS. 9 and 10 are views showing document data save-related operation windows displayed by the printer driver 505. The process to save document data will be explained according to a document data save flowchart shown in FIG. 8 with reference to FIGS. 9 and 10.

In step S1001, the user selects the print menu from the menu of the application software 508. Then, the OS 502 displays the operation window shown in FIG. 4. If the user designates the property key 207 in the operation window shown in FIG. 4, the printer driver 505 displays the operation window shown in FIG. 9. In step S1002, the user selects “save” as the output destination in the operation window (property sheet) of the printer driver 505, and selects the save destination of document data.

### (Exemplary Operation Window Related to Save of Document Data)

In FIG. 9, an output method setting column 802 is used to select the output destination of document data. In step S1002, the printer driver 505 selects “save” from choices displayed in the output method setting column 802 in accordance with an instruction from the user. If “save” is selected as the output destination, a save destination setting portion 803 shown in FIG. 9 is displayed. In step S1002, the user also selects (sets) a save destination via the save destination setting portion 803.

FIG. 10 shows an operation window displayed when the user selects (sets) a save destination via the save destination setting portion 803. In FIG. 10, reference numeral 901 denotes a save destination setup dialog, reference numeral 902 denotes a save destination box number, and 903 denotes a box name assigned to the box number 902. As shown in FIG. 10, the printer driver 505 can designate the save destination of document data. Since it is difficult to recognize a save destination from only the save destination box number 902, the box name 903 can be set for the save destination box number 902. For example, when the user wants to save target document data at a save destination having the box number 902 “0” and the box name 903 “notice for all departments”, the user only selects the target line with the mouse. After the end of selecting the save destination, the user selects an OK key 904 to set the selected save destination, and returns to the operation window shown in FIG. 9. By selecting an OK key 804 in the operation window shown in FIG. 9, contents set via the operation window are held. To cancel selection of the save destination, the user selects a cancel key 905 in the operation window shown in FIG. 9.

Referring back to FIG. 8, in step S1003, the application software 508 instructs the graphic driver 507 of the printer driver 505 via the OS 502 to start printing. In step S1004, the graphic driver 507 reads out the setting values of print attributes saved in the printer driver setting save area 503 of the OS 502. Further, the graphic driver 507 sets a print attribute setting code directed to the printer 103, and transmits it to the printer 1.03.

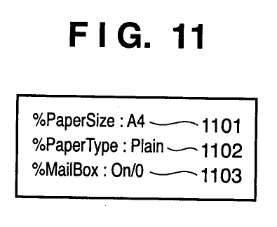

FIG. 11 is a view showing part (print codes) of the header of a print job generated by the printer driver 505.

In FIG. 11, a print code 1101 describes a paper size setting, and in the embodiment, represents that A4-size print paper is set. A print code 1102 describes a print paper type setting, and in the embodiment, represents that Plain (meaning plain paper) is set. A print code 1103 describes a save destination code. “On” means that a save destination is selected, and a figure after “/” means the box number of the save destination. In the embodiment, the box number 902 “0” is designated. That is, a print job containing the print codes shown in FIG. 11 is saved in a save area indicated by the box number 902 “0”. When the print code 1103 describes “Off”, printing is executed based on the print job.

Referring back to FIG. 8, in step S1005, the application software 508 performs print rendering via the OS 502 based on document data. In step S1006, the graphic driver 507 is instructed to perform print rendering designated via the OS 502. The graphic driver 507 converts the received print rendering instruction into a print job interpretable by the printer 103, and transmits it to the printer 103.

The printer 103 saves the received print job at a proper save destination in the printer 103, in the embodiment, at the save destination indicated by the box number 902 “0”.

### Exemplary Arrangement of Printer According to Embodiment

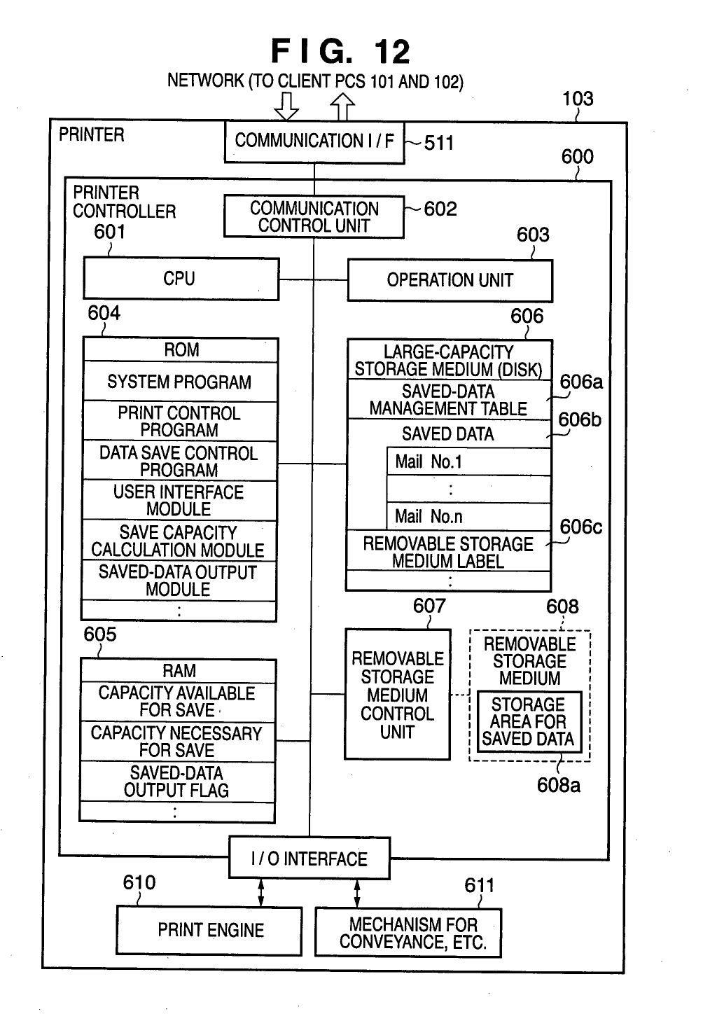

FIG. 12 is a block diagram showing the arrangement of the printer 103 according to the present embodiment. As described above, the external storage medium in the present invention is not limited to the save area of the printer 103. The printer 103 may be a multi-functional peripheral having scanner and facsimile functions. In FIG. 12, a general printer will be exemplified as the printer 103.

In the embodiment, the printer 103 includes a printer controller 600, a print engine 610 for executing a print process, and a mechanism 611 for conveyance and the like. Techniques associated with the present embodiment are the arrangement and operation of the printer controller 600, which will be described in detail.

The printer controller 600 includes an arithmetic control CPU 601 and communication control unit 602. The CPU 601 controls the whole printer. The communication control unit 602 controls the communication between the network-connected client PCs 101 and 102 via the communication I/F 511. The printer controller 600 also includes an operation unit 603 having a display unit and input unit. The display unit displays the status of the printer 103, job contents, data save contents, and the like. The input unit is used when the user inputs an instruction to the printer 103.

The printer controller 600 further includes a ROM 604 which stores fixed parameters and programs executed by the CPU 601. As programs associated with the present embodiment, the ROM 604 stores, e.g., a system program, print control program, and data save control program. As subroutines or the like, the ROM 604 stores, e.g., a user interface module, a save capacity calculation module to calculate the free capacity of a storage medium for data save, and a saved-data output module to back up saved data in a removable storage medium.

The printer controller 600 includes a RAM 605 used as the primary storage area of various data when the CPU 601 executes a program in the ROM 604. The RAM 605 contains an area having a capacity available for save calculated by the save capacity calculation module, and an area having a capacity necessary to newly save a print job. The RAM 605 also contains an area to store a saved-data output flag at which the saved-data output module holds the result of determining whether to back up saved data in a removable storage medium. The RAM 605 may hold device function information.

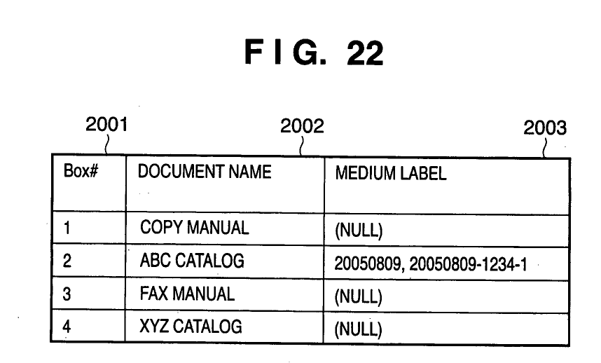

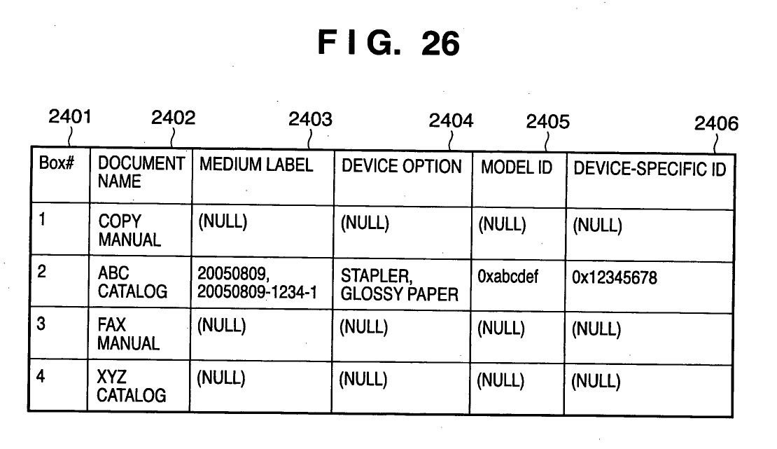

A large-capacity storage medium 606 is, for example, a hard disk to store target data. As data associated with the present embodiment, the large-capacity storage medium 606 holds a saved-data management table 606a shown in FIG. 22 or 26. The large-capacity storage medium 606 also holds saved data 606b managed by a Mail number. Of the saved data 606b, data backed up in an external removable storage medium is deleted to free the area, which will be described later. However, information representing the attribute of the backup data is held. Upon receiving a display instruction, the printer controller 600 can display attribute information about backup data on the operation panel. The large-capacity storage medium 606 further holds a removable storage medium label 606c printed when saved data is backed up in an external removable storage medium. The removable storage medium label 606c may also be created in the RAM 605 in accordance with a format stored in the ROM 604. The present embodiment has described the removable storage medium label, but the present invention is not limited to this.

A removable storage medium control unit 607 controls write/read in/from a removable storage medium 608. The removable storage medium control unit 607 is a floppy® controller when the removable storage medium 608 is a floppy® disk, a CD controller when the removable storage medium 608 is a CD, and a memory interface when the removable storage medium 608 is a memory stick. The removable storage medium 608 contains a storage area 608a for saved data to be backed up.

### Exemplary Printer Operation According to Embodiment

An operation of the printer 103 having the above-described arrangement in the present embodiment will be explained.

### (Exemplary Overall Control Procedures)

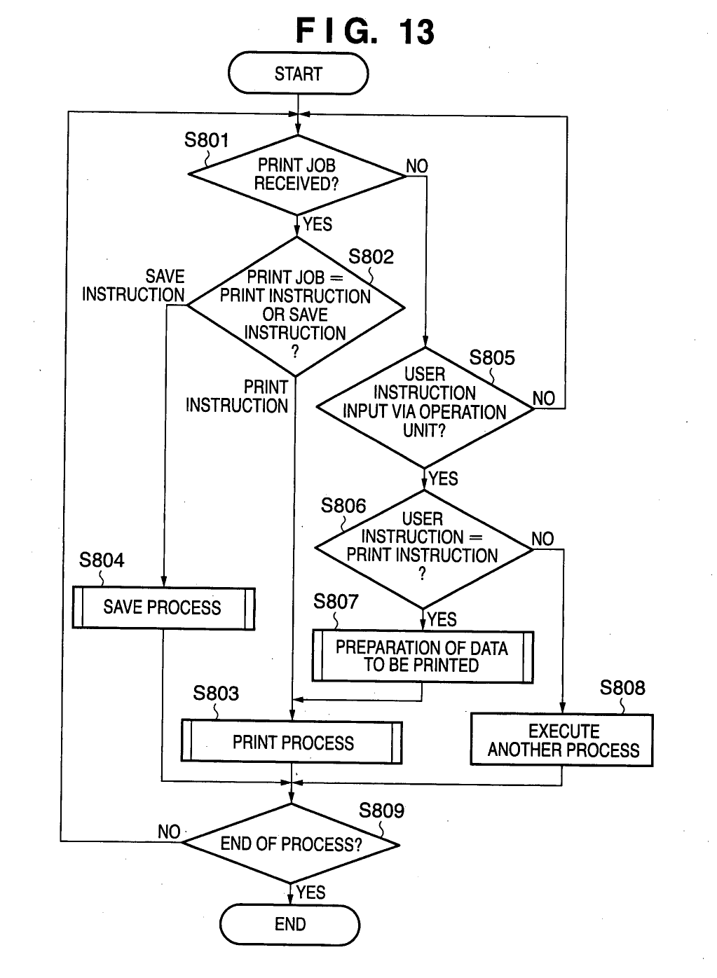

FIG. 13 is a flowchart schematically showing operation procedures by the printer 103 according to the present embodiment. The CPU 601 executes processes in steps of FIG. 13.

In step S801, the printer controller 600 determines whether it has received a print job from the client PC 101. If the printer controller 600 has received a print job, the CPU 601 determines in step S802 which of print and save instructions has been received as the print job. This determination is executed by analyzing “ON” or “OFF” described at part (print code) of the header of the print job shown in FIG. 11.

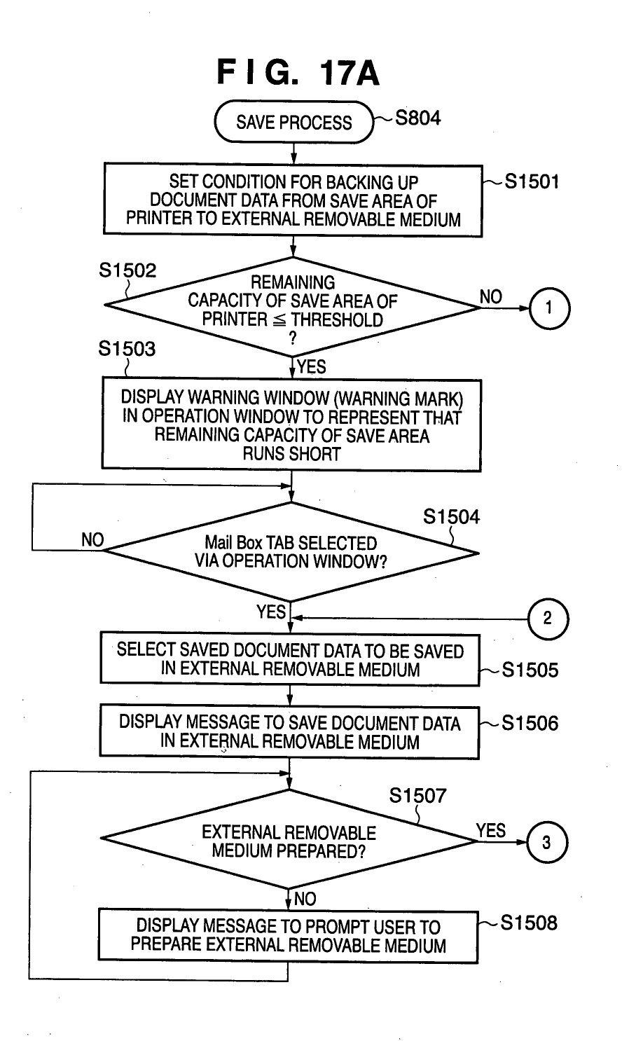

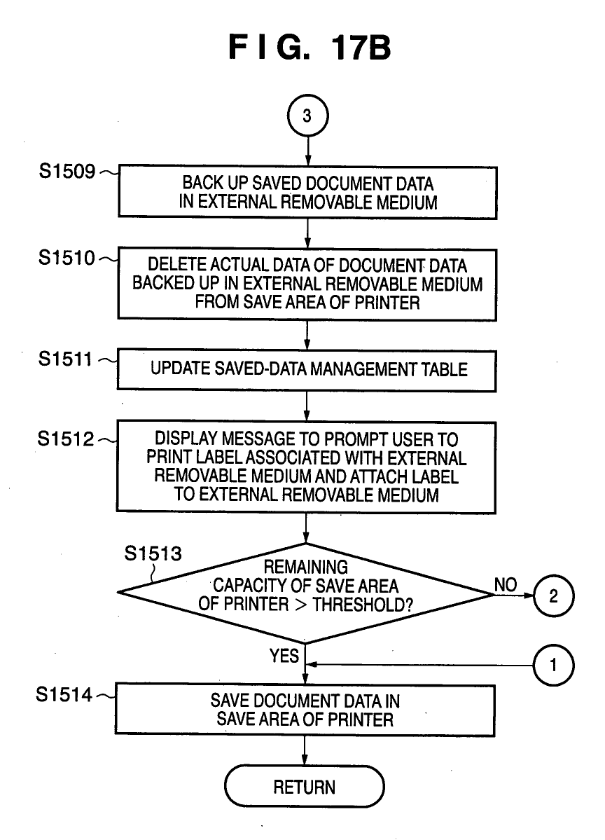

If the print job is a print instruction, the print engine 610 executes in step S803 a print process based on the print job received in step S801. If the print job is a save instruction, the printer controller 600 executes a save process in step S804 to save document data based on the print job at a save destination designated by the print job received in step S801. The save process in step S804 will be explained in detail with reference to FIGS. 17A and 17B.

If the printer controller 600 has not received any print job in step S801, it determines in step S805 whether the user has input an instruction via the operation unit 603. If the printer controller 600 determines that the user has not input any instruction, the process returns to step S801. If the printer controller 600 determines that the user has input an instruction, it determines in step S806 whether the user instruction is a print instruction. If the printer controller 600 determines that the user instruction is not a print instruction, it executes another process designated by the user in step S808.

If the printer controller 600 determines in step S806 that the user instruction is a print instruction, it prepares print data in step S807. More specifically, if print data selected by the user is saved in the large-capacity storage medium 606, the process advances to step S803 to execute the print process. If print data selected by the user is backed up in the removable storage medium 608, the removable storage medium control unit 607 reads the selected print data from the removable storage medium 608. Then, the process advances to step S803 to execute the print process.

In step S809, the printer controller 600 determines the end of the process (e.g., power-off). If the process is to end, it ends; if it is not to end, the process returns to step S801.

### (Exemplary Normal Procedures to Save Document Data and Print Saved Document Data)

To clarify features and effects of the present embodiment, exemplary normal procedures to save document data and print saved document data will be described in brief.

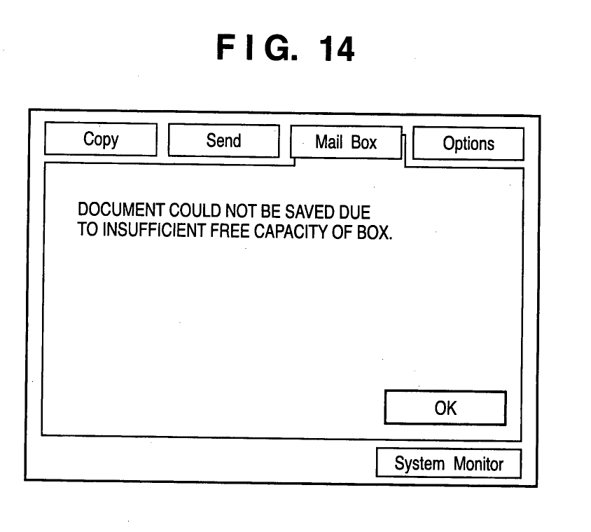

For example, a print job to save document data is transmitted to the printer 103, but no document data can be saved due to an insufficient capacity of the storage area at the save destination. Conventionally in this case, the printer 103 displays a window shown in FIG. 14 on the operation panel to notify the user that no document data can be saved. In response to this, the user searches saved document data for document data of low necessity or document data which need not be saved any more, and deletes such document data to increase the storage area to a necessary capacity or more. Then, the user saves necessary document data again.

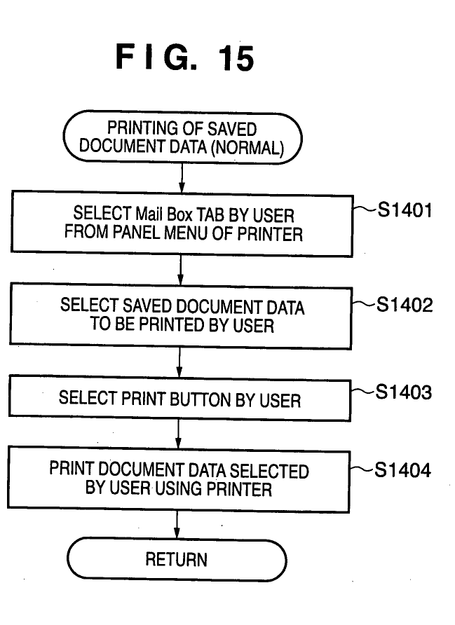

Procedures to print document data saved at the save destination in the printer 103 will be explained with reference to FIG. 15.

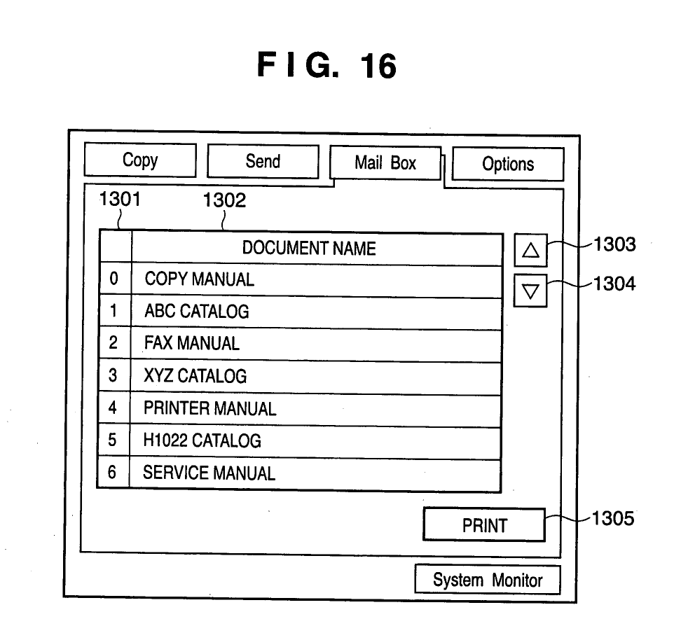

In step S1401, the user selects the Mail Box tab from the panel menu (panel menu in the window shown in FIG. 14) of the printer 103. Then, the printer controller 600 displays a Mail Box tab window shown in FIG. 16.

FIG. 16 shows a window displayed-when the user selects the Mail Box tab from the panel menu in the window shown in FIG. 14. Reference numeral 1301 denotes a number assigned to saved document data, and reference numeral 1302 denotes a document name assigned to the saved document data. When there are a number of document data which cannot be displayed in the window shown in FIG. 16, the user can change the display range by selecting buttons 1303 and 1304 to scroll the display. A print button 1305 is used to print selected document data.

Referring back to FIG. 15, in step S1402, the user selects saved document data to be printed via the window shown in FIG. 16. In other words, the printer controller 600 selects the document data designated by the user. In step S1403, the user selects the print button 1305 in the window shown in FIG. 16. In step S1404, the print engine 610 of the printer 103 prints the document data selected in step S1402 in accordance with the selection by the user with the print button 1305.

The flowchart shown in FIG. 15 is a process when the storage medium of the printer 103 holds document data to be printed. When the storage medium of the printer 103 does not hold document data to be printed, e.g., when document data backed up in a removable medium is to be printed, the user must search for the removable medium holding the document data, and cannot print quickly. In this manner, when data held in an external storage medium of the printer 103 is selected as a print target, search for a removable medium, management of it, and the like impair user friendliness.

### Exemplary Procedures to Save Document Data and Print Saved Document Data According to First Embodiment

Procedures to save document data and print saved document data according to the first embodiment, which solves the above-described problems, will be described.

### (Save of Document Data in External Removable Medium)

In the above-mentioned normal save of document data in the printer 103, if the printer 103 cannot ensure a sufficient document data save area, no document data can be saved. As for the document data save function, the first embodiment provides a new method of ensuring a save area by backing up target document data in an external removable storage medium (to be also referred to as an external removable medium hereinafter) when the document data save area runs short.

In the first embodiment, the printer 103 incorporates or is connected to an external removable medium, and can save target document data in it.

FIGS. 17A to 23 are views for explaining the first embodiment. The first embodiment will be explained according to flowcharts shown in FIGS. 17A and 17B.

In step S1501, a printer controller 600 sets a condition for shifting document data from the save area of a printer 103 to an external removable medium. In the first embodiment, when the remaining capacity of the save area of the printer 103 runs short, document data is backed up in an external removable medium. The document data saved in the printer 103 is deleted to ensure a sufficient remaining capacity. At this time, the condition of the remaining capacity of the printer 103 to back up document data in an external removable medium must be decided. Several examples of this condition are conceivable: the remaining capacity becomes smaller than a predetermined ratio of the total capacity of the save area, the remaining capacity becomes equal to or smaller than a concrete value such as 50 MB, and the remaining capacity reaches a value set by the user. When a condition (threshold) stored in the ROM in advance is used, step S1501 is omitted.

In step S1502, the printer controller 600 determines whether the remaining capacity of the save area of the printer 103 becomes equal to or smaller than the threshold set in step S1501. That is, the printer controller 600 monitors the remaining capacity of the storage medium (first storage medium) of the printer 103.

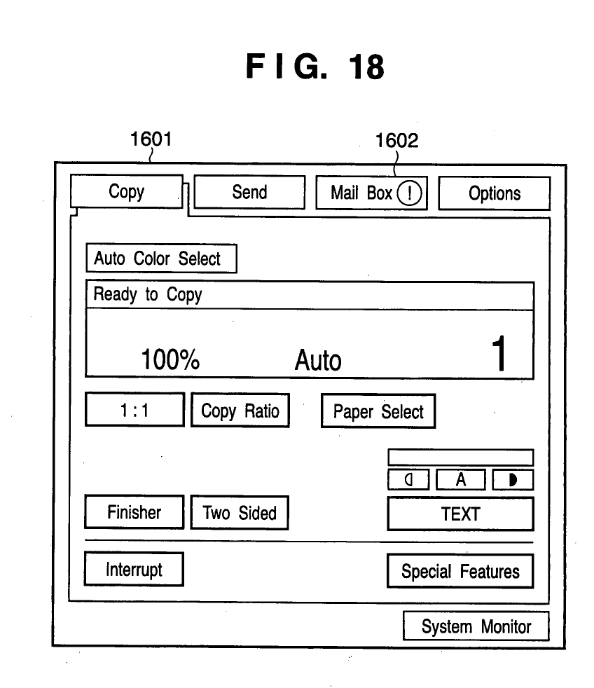

If the remaining capacity of the save area of the printer 103 becomes equal to or smaller than the threshold, the process advances to step S1503; if the remaining capacity of the save area of the printer 103 is larger than the threshold, to step S1514. In step S1514, the printer controller 600 saves document data based on a received print job in the save area of the printer 103, and updates the save table. In step S1503, the printer controller 600 displays a warning window (warning mark) in the operation window to represent that the remaining capacity of the save area of the document data runs short. FIG. 18 shows an example of the warning window in step S1503. The warning window shown in FIG. 18 is a normal operation window 1601. The warning is output by displaying an exclamation mark (warning mark) 1602 at the Mail Box tab for selecting a saved document.

In step S1504, the printer controller 600 determines whether the user has selected the Mail Box tab via the operation window. In other words, the printer controller 600 determines whether the user has performed an operation associated with the Mail Box tab. If the user confirms the exclamation mark 1602 and selects the Mail Box tab, the process advances to step S1505; if the user has not selected the Mail Box tab, the process waits until he selects the Mail Box tab.

In step S1505, the printer controller 600 selects saved document data to be saved in an external removable medium. In step S1505, saved document data may be selected according to a predetermined save policy of an external removable medium. Alternatively, saved document data to be backed up (saved) in an external removable medium may be selected in accordance with an instruction from the user. The save policy of an external removable medium is a rule to decide which saved document data is to be backed up (saved) in an external removable medium. This rule includes various methods. For example, the following document data (1) to (4) are backed up in an external removable medium:

(1) document data saved on the oldest date and time among all saved document data;

(2) document data of the largest capacity among all saved document data;

(3) document data saved on the oldest date and time among saved document data for each owner (user who designates save) of saved document data; and

(4) document data of the largest capacity among saved document data for each owner (user who designates save) of saved document data.

This rule is merely an example, and another rule is also applicable as long as document data to be backed up (saved) in an external removable medium can be specified. In step S1505, upon receiving a new print job to be saved, the printer controller 600 determines whether the print job can be saved. If the printer controller 600 determines that no print job can be saved, the print job may be saved in the external removable medium. Assume that document data of a document name “ABC catalog” shown in FIG. 16 is to be saved in the external removable medium.

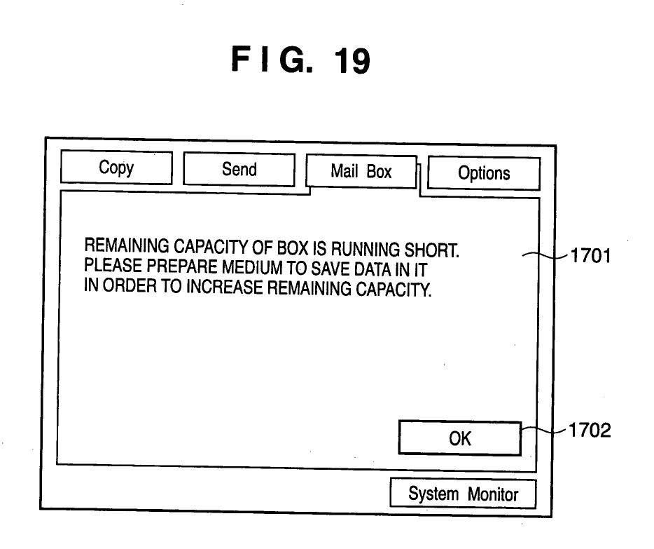

In step S1506, the printer controller 600 displays a message in the operation window of the printer 103 to save document data in the external removable medium. FIG. 19 shows an example of a message 1701 displayed in the operation window in step S1506. The message 1701 represents that the document data save area runs short, and prompts the user to prepare an external removable medium. If the printer controller 600 recognizes that the user has selected an OK button 1702, the process advances to step S1507.

In step S1507, the printer controller 600 determines whether the external removable medium has been prepared. The preparation of the external removable medium is determined by determining whether it has been inserted. If no external removable medium has been prepared, the process advances to step S1508. The printer controller 600 displays a message in the operation window to prompt the user to prepare an external removable medium.

If the external removable medium has been prepared, the printer controller 600 saves the saved document data selected step S1505 in the external removable medium in step S1509. In step S1510, the printer controller 600 deletes actual data of the document data saved in the external removable medium from the save area of the printer 103. That is, the printer controller 600 stores the document data selected in step S1505 in the external removable medium (second storage medium). The printer controller 600 leaves, in the storage medium of the printer 103, information capable of identifying the document data selected in step S1505, and deletes the selected document data from the storage medium of the printer 103. In step S1511, the printer controller 600 updates a saved-data management table 606a.

### Exemplary Saved-data Management Table According to First Embodiment

The saved-data management table 606a will be explained. The saved-data management table 606a manages document data saved in the printer 103, and has a table form shown in FIG. 22.

Reference numeral 2001 denotes a save box name, reference numeral 2002 denotes a document-name, and reference numeral 2003 denotes a medium label (label name) corresponding to a removable medium. The medium label column holds so-called (NULL) meaning that nothing is set, or an arbitrary character string. When (NULL) is set in the medium label column, corresponding document data is saved in the save area of the printer 103. Note that document data is obtained by changing a received print job for save. When an arbitrary character string is set in the medium label column, document data corresponding to this character string is saved in an external removable medium. The medium label column of document data saved in the external removable medium will be explained. The medium label column has two fields. The first field is a date-field where document data is saved in an external removable medium in the format of year (four digits), month (two digits), and date (two digits). The second field holds a medium number automatically generated by the printer 103. In this case, the medium number is a date-sequential number in save.

Referring back to FIGS. 17A and 17B, in step S1511, the printer controller 600 updates the management state of the document data selected in step S1505 to represent that the document data is saved in the external removable medium. For example, in the present embodiment, “ABC catalog” is selected as a save target in the external removable medium. The printer controller 600 generates a medium label for the saved document “ABC catalog”, and updates the medium label of the saved-data management table.

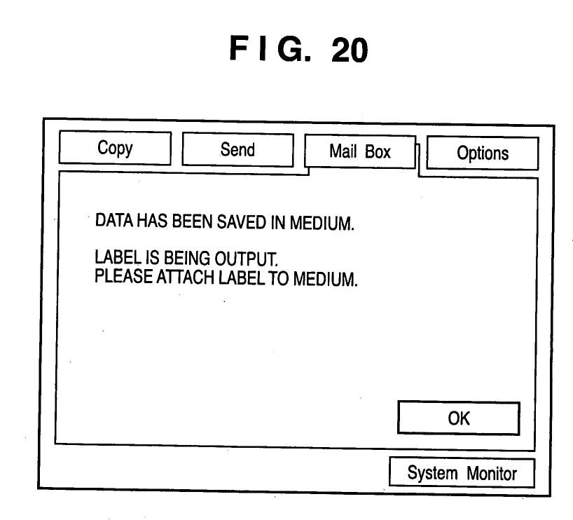

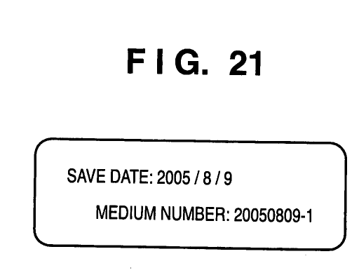

In step S1512, a print engine 610 displays a message in the operation window to prompt the user to print (output) a label associated with the external removable medium and attach the label to the external removable medium. FIG. 20 shows an example of the message which is displayed in the operation window of the printer 103 and prompts the user to attach a printed label to the external removable medium. FIG. 21 shows a label associated with the external removable medium. That is, to represent that the selected document data is stored in the external removable medium, the print engine 610 prints, on a print medium, information capable of identifying the selected document data. In FIG. 21, the save date and the medium number generated in step S1511 are printed. The user attaches the printed label to the external removable medium which saves the document data, or associates the document data by any method with the external removable medium which saves the document data.

In step S1513, the printer controller 600 determines whether the remaining capacity of the save area of the printer 103 exceeds the threshold. If the remaining capacity of the save area of the printer 103 does not exceed the threshold, the process returns to step S1505. If the remaining capacity of the save area of the printer 103 exceeds the threshold, the process advances to step S1514, and the printer controller 600 saves the document data in the save area of the printer 103. At this time, the printer controller 600 updates the saved-data management table.

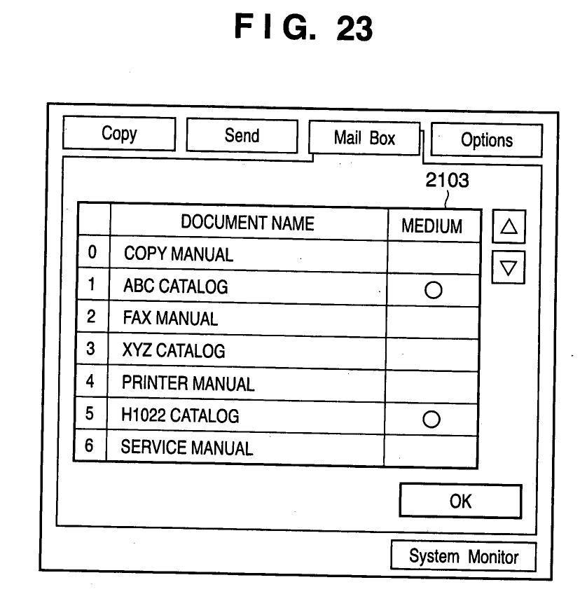

FIG. 23 shows the operation window of the printer 103 having a function of saving document data in an external removable medium. Referring to FIG. 23, a medium column 2103 is added to the above-described saved-document data operation window. As for document data with a mark (O) in the medium column 2103, its actual data is saved not in the printer 103 but in an external removable medium.

### Exemplary Saved Document Data According to First and Second Embodiments

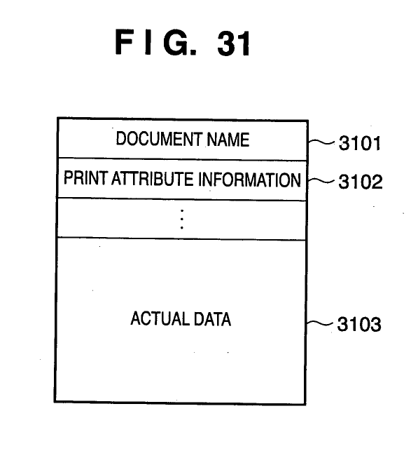

FIG. 31 shows the structure of document data saved in the save area of a printer 103.

As shown in FIG. 31, document data contains a document name 3101 for identifying the document data, print attribute information 3102 set for the document data, and actual data 3103. If no new print job can be saved in the save area of the printer 103, a printer controller 600 erases the actual data 3103 of document data to be backed up in the external removable medium.

### Exemplary Procedures to Print Document Data Saved in External Removable Medium According to First Embodiment

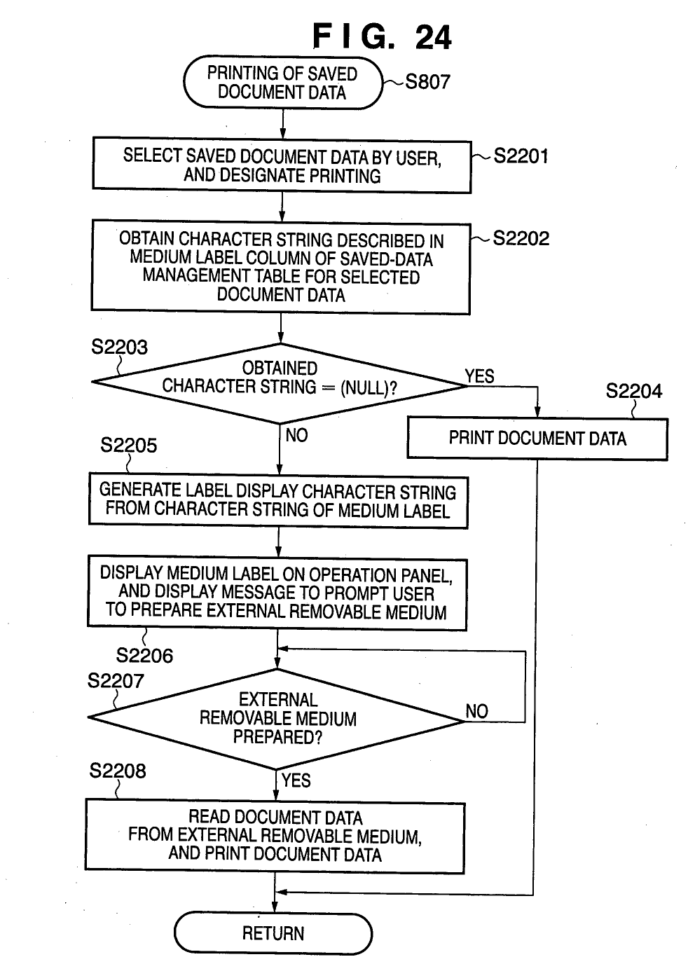

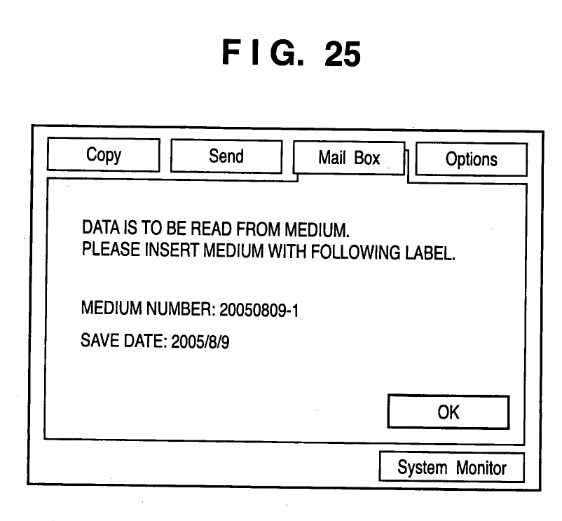

A method of printing (outputting) document data saved in an external removable medium by the user will be explained. FIGS. 24 and 25 are views for explaining an operation when document data saved in an external removable medium is designated as a print target. A CPU 601 of the printer 103 also executes processes in the flowchart shown in FIG. 24. To accept document data to be printed, the printer controller 600 displays a window containing information capable of identifying document data selected in step S1505.

Referring to FIG. 24, in step S2201, the user selects saved document data and designates printing. That is, the printer controller 600 designates printing of the document data selected by the user. Assume that the user designates printing of document data “ABC catalog” in the list of saved document data in the operation window shown in FIG. 23.

In step S2202, the printer controller 600 obtains a character string described in the medium label column of the saved-data management table (FIG. 22) for the document data selected in step S2201. In the present embodiment, the print target is “ABC catalog”, so the obtained character string is “20050809, 20050809-1”.

In step S2203, the printer controller 600 determines whether the obtained character string is (NULL). Since the character string is not (NULL) for “ABC catalog”, the process advances to step S2205. If the character string is (NULL), no actual data of the document data is backed up in the external removable medium. Thus, the printer controller 600 executes normal saved-document data printing to print the document data in step S2204.

In step S2205, the printer controller 600 generates a label display character string to be displayed in the operation window from the character string of the medium label. In the present embodiment, the printer controller 600 generates a date and label name from the character string “20050809, 20050809-1” corresponding to the selected “ABC catalog”. More specifically, the printer controller 600 generates a character string “200518/9, 20050809-1”.

In step S2206, the printer controller 600 displays the medium label in the operation window, and displays a message to prompt the user to prepare an external removable medium. In other words, when the target document data selected in step S2201 is stored in an external removable medium, the printer controller 600 notifies the user to insert the external removable medium. FIG. 25 shows an exemplary message displayed in step S2206 to prompt the user to prepare an external removable medium.

In step S2207, the printer controller 600 determines whether the external removable medium has been prepared. If the external removable medium has been prepared, the printer controller 600 reads the document data from the external removable medium and prints it in step S2208. More specifically, the printer controller 600 prints using actual data saved in the external removable medium. The printer controller 600 reads out actual data to be printed based on the name of the document data saved in the external removable medium and the name of the document data selected in step S2201. For example, since “ABC catalog” is selected in step S2201, the printer controller 600 specifies actual data of the name “ABC catalog” among document data saved in the prepared removable medium. The printer controller 600 reads out and prints the specified document data.

In this fashion, document data saved in the printer 103 is saved in an external removable medium, and document data saved in the external removable medium is printed. This can prevent a failure to execute a process desired by the user due to a save error even when the printer cannot save a received print job. In backing up document data in an external removable medium, a label (print medium) bearing information representing the relationship with the document data is output. The label facilitates management of the external removable medium in which the document data is backed up. For example, the user can easily specify a proper external removable medium when preparing (inserting) it and printing.

### Exemplary Procedures to Save Document Data and Print Saved Document Data According to Second Embodiment

FIGS. 26 to 30 are views for explaining procedures to save document data and print saved document data according to the second embodiment. The configuration of the system and apparatus in the second embodiment are the same as that in the first embodiment, and only a difference will be described.

Procedures to save document data in an external removable medium are the same as those in the flowcharts shown in FIGS. 17A and 17B. However, the saved-data management table used in step S1511 is different from that in the first embodiment, and thus will be explained.

### Exemplary Saved-data Management Table According to Second Embodiment

FIG. 26 shows a saved-data management table according to, the second embodiment. In FIG. 26, reference numeral 2401 denotes a save box name, reference numeral 2402 denotes a document name, and reference numeral 2403 denotes a medium label (label name) corresponding to a removable medium. Reference numeral. 2404 denotes a device option describing the optional arrangement of a printer 103 or the like, reference numeral 2405 denotes a model ID representing a model, and reference numeral 2406 denotes a device-specific ID for specifying a device. Assume that the printer has a stapler, and glossy paper is used to output document data. At this time, the stapler and glossy paper are recorded in the device option column. Printer IDs, e.g., 0xabcdef and 0x12345678 in the second embodiment are recorded in the model ID column and device-specific ID column.

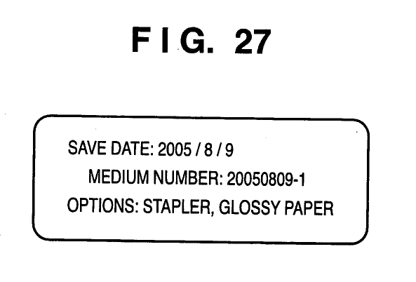

In the second embodiment, a print engine 610 prints a label containing device options in step S1512 of FIG. 17B. FIG. 27 shows an example of the label printed in step S1512 according to the second embodiment. Device options necessary to print are printed. Contents described in the label are the same as those in the device option column of the saved-data management table shown in FIG. 26.

### Exemplary Procedures to Print Document Data Saved in External Removable Medium According to Second Embodiment

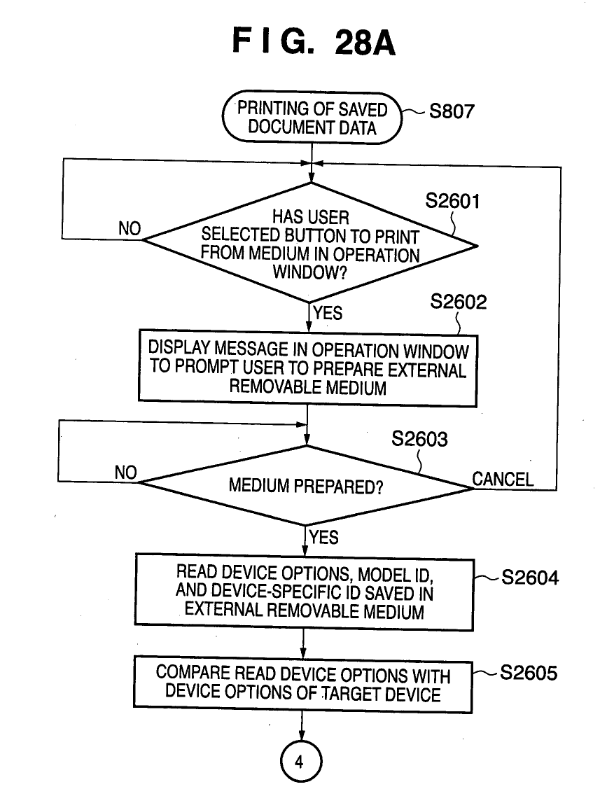

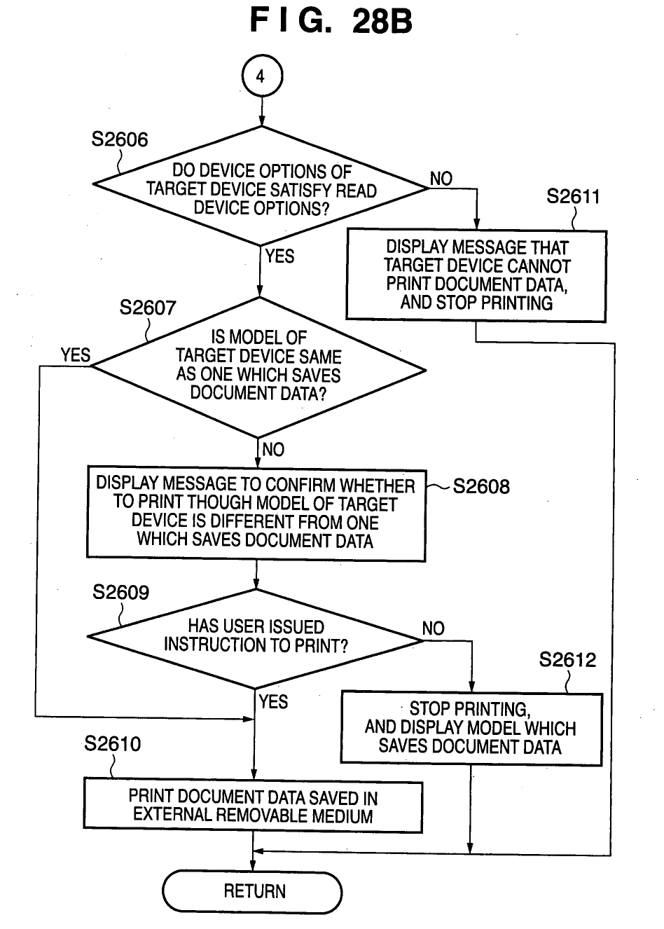

Procedures to print using an external removable medium by a printer different from one which saves document data will be explained. FIGS. 28A and 28B are flowcharts showing the procedures to print by a printer different from one which saves document data. As described above, a printer used to print is not the same as one which saves document data.

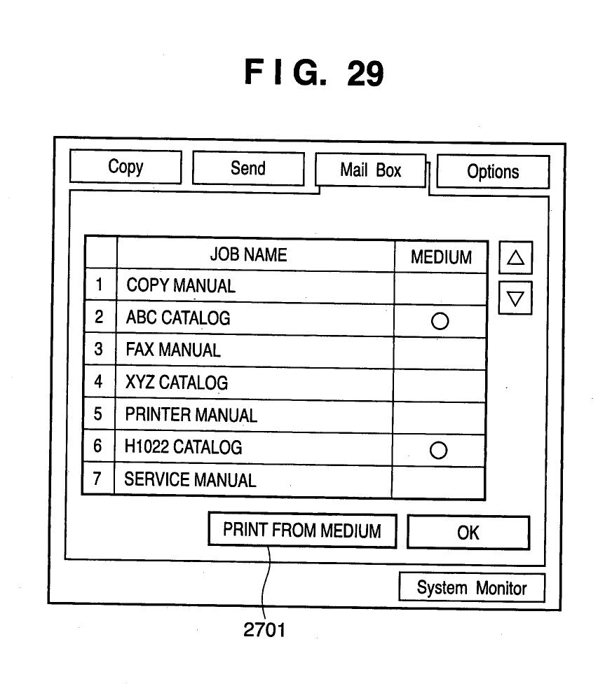

In step S2601, a printer controller 600 determines whether the user has selected a button 2701 to print from a medium via an operation window (FIG. 29). FIG. 29 shows the operation window of the printer. By selecting the button 2701, the user can designate printing from an external removable medium.

If the user selects the button 2701, the printer controller 600 displays a message in the operation window of the printer in step S2602 to prompt the user to prepare an external removable medium. In step S2603, the printer controller 600 determines whether the external removable medium has been prepared. If no external removable medium has been prepared, the process waits until the external removable medium is prepared. If the external removable medium has been prepared, the operation window displays document data saved in the external removable medium, and the user selects data to be printed.

In step S2604, the printer controller 600 reads the document data selected by the user via the operation window, and also reads device options, a model ID, and a device-specific ID, which are saved at the same time as the document data, from the prepared external removable medium. In this case, “stapler, glossy paper”, “0xabcdef”, and “0x12345678” are read. If the prepared external removable medium saves a plurality of document data, the printer controller 600 displays information saved in the external removable medium in the operation window, and determines the document data selected by the user via the operation window as data to be printed.

The printer controller 600 reads, from the external removable medium, device options necessary to process the document data to be printed. Document data saved in the external removable medium corresponds to device options necessary for a print process. By specifying data to be printed, the printer controller 600 can obtain device options corresponding to the data.

In step S2605, the printer controller 600 compares the device options read in step S2604 with those of the target printer. In step S2606, the printer controller 600 determines whether the device options of the target printer satisfy the device options read in step S2604. That is, the printer controller 600 reads, from the external removable medium, the selected document data, and information on functions necessary to process the selected document data. The printer controller 600 compares the read information on functions with information on functions processible by the printer, and determines whether the selected document data is processible. In this case, the printer controller 600 determines that the read device options are satisfied, and the process advances to step S2607. If no read device option is satisfied, the printer controller 600 displays a message in the operation window of the printer in step S2611 to notify the user that the current device cannot print the document data. The printer controller 600 holds the configuration (functional information) of the device options of the target printer, and information (model ID) for identifying a model.

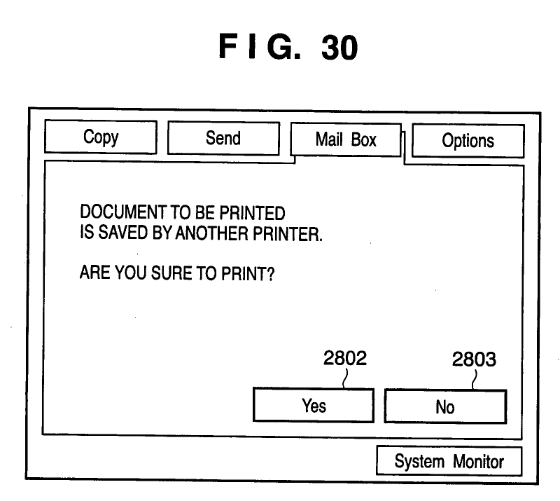

In step S2607, the printer controller 600 compares the model ID read in step S2604 with the model ID held of the target printer, and determines whether the model of the target printer is the same as one which saves the document data. If the model of the target printer is the same as one which saves the document data, the document data can be directly printed (output). In step S2610, the print engine 610 prints the document data saved in the external removable medium. If the model of the target printer is not the same as one which saves the document data, the user may not want to print in terms of image quality and the like. Hence, the process advances to step S2608. In step S2608, the printer controller 600 displays a message in the operation window to confirm whether to print though the model of the target printer is different from one which saves the document data. FIG. 30 shows an example of the message displayed in the operation window of the printer in step S2608. The operation window shown in FIG. 30 includes an Yes button 2802 and No button 2803 for confirming the user's intention. The user selects the Yes button 2802 to print though the model of the target printer is different from one which saves the document data, and the No button 2803 to stop printing.

In step S2609, the printer controller 600 determines whether the user instructs it to print. That is, if the user selects the Yes button 2802 via the operation window shown in FIG. 30, the printer controller 600 prints the document data saved in the external removable medium in step S2610. If the user selects the No button 2803 via the operation window shown in FIG. 30, the printer controller 600 stops printing in step S2612, and displays the model which saves the document data, as reference information for the user in the operation window of the printer.

According to the second embodiment, when an external removable medium is inserted into an image processing apparatus having no function necessary to process (print) selected document data, no print process is executed, preventing a print process not intended by the user.

### EXAMPLE OF FUNCTIONAL BLOCKS OF IMAGE PROCESSING APPARATUS ACCORDING TO EMBODIMENT

### Functional Block Example 1

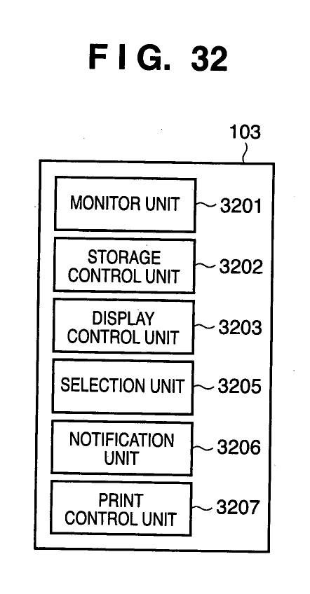

FIG. 32 is a block diagram showing the functional blocks of a printer 103 serving as the image processing apparatus according to the embodiment.

The image processing apparatus (printer 103) comprises a monitor unit 3201, storage control unit 3202, display control unit 3203, selection unit 3205, notification unit 3206, and print control unit 3207. The monitor unit 3201 monitors the free capacity (remaining capacity) of the storage medium of the image processing apparatus. When the monitor unit 3201 determines that no new document data can be saved, the storage control unit 3202 stores selected document data in a removable external storage medium. The storage control unit 3202 leaves, in the storage medium of the image processing apparatus, information capable of identifying the selected document data, and deletes the selected document data from the storage medium of the image processing apparatus.

The display control unit 3203 displays a selection window containing the identifiable information so as to accept selection of document data to be printed.

The selection unit 3205 selects data to be printed from document data selected via the selection window.

When a removable external storage medium stores the data selected by the selection unit 3205, the notification unit 3206 notifies the user to mount the removable external storage medium.

The print control unit 3207 controls to print the data selected by the selection unit 3205 from the notified removable external storage medium.

### Functional Block Example 2

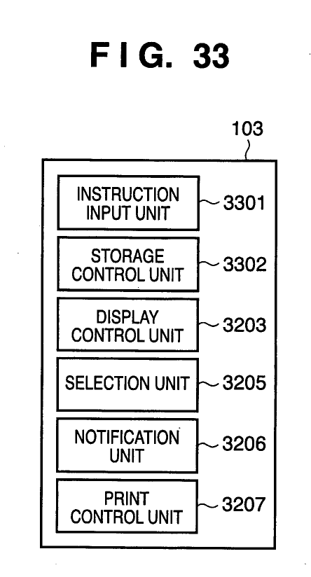

FIG. 33 is a block diagram showing another example of the functional blocks of the printer 103 serving as the image processing apparatus according to the embodiment.

The image processing apparatus (printer 103) comprises an instruction input unit 3301, a storage control unit 3302, the display control unit 3203, the selection unit 3205, the notification unit 3206, and the print control unit 3207.

The instruction input unit 3301 designates and inputs document data to be stored in the second removable storage medium in accordance with an instruction from the user.

The storage control unit 3302 leaves, in the storage medium of the image processing apparatus, information capable of identifying the document data designated by the instruction input unit 3301, and deletes the designated document data from the storage medium of the image processing apparatus.

### Functional Block Example 3

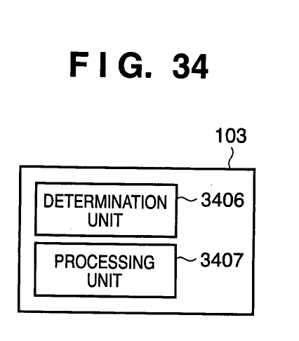

FIG. 34 is a block diagram showing still another example of the functional blocks of the printer 103 serving as the image processing apparatus according to the embodiment.

The image processing apparatus (printer 103) comprises a determination unit 3406 and processing unit 3407.

The determination unit 3406 reads, from a removable external removable medium, selected document data, and information on functions necessary to process the selected document data. The determination unit 3406 compares the read information on functions with information on functions which are provided by the image processing apparatus and can process the document data. The determination unit 3406 determines whether the functions of the image processing apparatus can process the selected document data.

When the determination unit 3406 determines that the functions of the image processing apparatus can process the selected document data, the processing unit 3407 processes the document data read out from the removable external removable medium.

With these functional blocks, when document data is saved in an external removable medium, the external removable medium can be used to print the document data by another printer.

In the above-described embodiments, the operation window of the printer displays the save state, a warning of an insufficient free capacity (remaining capacity) of the save area of the printer, and the like. The same display may also be transmitted to a client computer and presented by it. In this case, the user can recognize the printer status in front of the client computer.

The present invention may be applied to a system including a plurality of devices (e.g., a host computer, interface device, and printer) or an apparatus formed by a single device.

The object of the present invention is also achieved by supplying a storage medium (or recording medium) which stores software program codes for implementing the functions of the above-described embodiments to a system or apparatus, and reading out and executing the program codes stored in the storage medium by the computer (or the CPU or MPU) of the system or apparatus.

In this case, the program codes read out from the storage medium implement the functions of the above-described embodiments, and the storage medium which stores the program codes constitutes the present invention.

The functions of the above-described embodiments are implemented when the computer executes the readout program codes. Also, the functions of the above-described embodiments are implemented when an OS (Operating System) or the like running on the computer performs some or all of actual processes on the basis of the instructions of the program codes.

Furthermore, the functions of the above-described embodiments are implemented by the following process. That is, the program codes read out from the storage medium are written in the memory of a function expansion card inserted into the computer or the memory of a function expansion unit connected to the computer. Then, the CPU of the function expansion card or function expansion unit performs some or all of actual processes on the basis of the instructions of the program codes.

When the present invention is applied to the storage medium, the storage medium stores program codes corresponding to the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-291716, filed Oct. 26, 2006, which is hereby incorporated by reference herein in its entirety.

What is claimed is:

1. An image processing apparatus comprising:
a first storage medium configured to save data transmitted from an external apparatus;
a monitor unit configured to monitor a free capacity of said first storage medium;
a storage control unit configured to, when said monitor unit determines that no new data can be saved, store selected data in a removable second storage medium, leave, in said first storage medium, identifiable information capable of identifying the selected data, and delete the selected data from said first storage medium;
a display control unit configured to display a selection window containing the identifiable information so as to accept selection of data to be printed;
a selection unit configured to select the data to be printed that is designated via the selection window displayed by said display control unit;
a notification unit configured to notify a user to mount the removable second storage medium when the data to be printed that is selected by said selection unit is stored in the removable second storage medium by said storage control unit; and
a print control unit configured to control to print the data to be printed that is selected by said selection unit according to mounting the removable second storage medium notified by said notification unit.

2. The apparatus according to claim 1, wherein said print control unit prints, on a print medium, the identifiable information capable of identifying the selected data, so as to represent that the data so selected as to be stored in the removable second storage medium is stored in the second storage medium.

3. The apparatus according to claim 2, further comprising a read unit configured to read out the data to be printed that is selected by said selection unit, from the removable second storage medium that is notified by said notification unit and to which the print medium bearing the identifiable information printed by said print control unit is attached.

4. The apparatus according to claim 3, wherein said storage control unit stores, together with storage data of said first storage medium, information representing that the removable second storage medium stores the data so selected as to be stored in the second storage medium, and the identifiable information capable of identifying the data, and
said notification unit determines, from the information representing that the removable second storage medium stores the data, that the data selected by said selection unit is stored in the second storage medium, and notifies the user to mount the removable second storage medium together with the identifiable information capable of identifying the data selected by said selection unit.

5. The apparatus according to claim 2, wherein the identifiable information capable of identifying the data contains at least a name of the data so selected as to be stored in the removable second storage medium, a date and time when the data is stored in the removable second storage medium, and information for specifying the second storage medium.

6. The apparatus according to claim 1, wherein said storage control unit selects data to be stored in the removable second storage medium in accordance with a predetermined data selection condition, and
the data selection condition includes one of conditions: data saved on the oldest date and time among saved data stored in said first storage medium, data of the largest capacity among the saved data, data saved on the oldest date and time among the saved data for each user who designates save, and data of the largest capacity among the saved data for each user who designates save.

7. The apparatus according to claim 2, wherein said storage control unit stores, in the removable second storage medium, information on a function necessary to process the data so selected as to be stored in the removable second storage medium, and
said print control unit prints, on the print medium, information on a function capable of processing the selected data.

8. The apparatus according to claim 7, wherein the information on the function contains at least one of option information, a model, and a specific ID of an apparatus.

9. The apparatus according to claim 7, further comprising a determination unit which determines whether a function of the image processing apparatus can process the selected data, by comparing the information, read from the removable second storage medium, about the function necessary to process the selected data with the information about the function which is provided by the image processing apparatus and can process the data.

10. The apparatus according to claim 9, further comprising a read unit configured to read out the selected data from the removable second storage medium when said determination unit determines that the function of the image processing apparatus can process the selected data,
wherein said read unit includes:
a unit configured to determine, from the information on the function read out from the removable second storage medium, whether the selected data is stored in the removable second storage medium by another information processing apparatus,
a unit configured to, when the selected data is determined to be stored in the removable second storage medium by said other information processing apparatus, inquire of a user whether to read out the selected data from the removable second storage medium and process the selected data, and
a unit configured to read out the selected data from the removable second storage medium in response to a permission input from the user.

11. The apparatus according to claim 1, wherein said first storage medium includes a storage medium which is arranged in the image processing apparatus having a print function and saves print data, and
the second storage medium includes a storage medium removable from an external removable medium control unit of the image processing apparatus having the print function.

12. An image processing apparatus comprising:
a determination unit configured to determine whether a function of the image processing apparatus can process selected data, by comparing information about a function which is provided by the image processing apparatus and can process data, with information about a function necessary to process the selected data that is read from a removable second storage medium storing the selected data and the information about the function; and
a processing unit configured to, when said determination unit determines that the function of the image processing apparatus can process the selected data, process the selected data read out from the removable second storage medium.

13. The apparatus according to claim 12, further comprising a read unit configured to read out the selected data from the removable second storage medium when said determination unit determines that the function of the image processing apparatus can process the selected data,
wherein said read unit includes:
a unit configured to determine, from the information on the function read out from the removable second storage medium, whether the selected data is stored in the removable second storage medium by another information processing apparatus,
a unit configured to, when the selected data is determined to be stored in the removable second storage medium by said other information processing apparatus, inquire of a user whether to read out the selected data from the removable second storage medium and process the selected data, and
a unit configured to read out the selected data from the removable second storage medium in response to a permission input from the user.

14. An image processing apparatus comprising:
a first storage medium configured to save data transmitted from an external apparatus;
an instruction input unit configured to designate and input data to be stored in a removable second storage medium in accordance with an instruction from a user;
a storage control unit configured to leave, in said first storage medium, identifiable information capable of identifying data designated by said instruction input unit, and delete the designated data from said first storage medium;
a display control unit configured to display a selection window containing the identifiable information so as to accept selection of data to be printed;
a selection unit configured to select the data to be printed that is designated via the selection window displayed by said display control unit;
a notification unit configured to notify the user to mount the removable second storage medium when the data to be printed that is selected by said selection unit is stored in the removable second storage medium by said storage control unit; and
a print control unit configured to control to print the data to be printed that is selected by said selection unit according to mounting the removable second storage medium notified by said notification unit.

15. An image processing method for an image processing apparatus having a first storage medium which saves data transmitted from an external apparatus, said image processing method comprising:
a monitor step of monitoring a free capacity of the first storage medium;
a storage control step of, when no new data is determined in the monitor step to be saved, storing selected data in a removable second storage medium, leaving, in the first storage medium, identifiable information capable of identifying the selected data, and deleting the selected data from the first storage medium;
a display control step of displaying a selection window containing the identifiable information so as to accept selection of data to be printed;
a selection step of selecting the data to be printed that is designated via the selection window displayed in the display control step;
a notification step of notifying a user to mount the removable second storage medium when the data to be printed that is selected in the selection step is stored in the removable second storage medium in the storage control step; and
a print control step of controlling to print the data to be printed that is selected in the selection step according to mounting the removable second storage medium notified in the notification step.

16. The method according to claim 15, wherein in the print control step, the identifiable information capable of identifying the selected data is printed on a print medium so as to represent that the data so selected as to be stored in the removable second storage medium is stored in the second storage medium.

17. The method according to claim 16, further comprising a read step of reading out the data to be printed that is selected in the selection step, from the removable second storage medium that is notified in the notification step and to which the print medium bearing the identifiable information printed in the print control step is attached.

18. The method according to claim 17, wherein in the storage control step, information representing that the removable second storage medium stores the data so selected as to be stored in the second storage medium, and the identifiable information capable of identifying the data are stored together with storage data of the first storage medium, and
in the notification step, the data selected in the selection step is determined, from the information representing that the removable second storage medium stores the data, to be stored in the second storage medium, and the user is notified to mount the removable second storage medium together with the identifiable information capable of identifying the data selected in the selection step.

19. The method according to claims 16, wherein the identifiable information capable of identifying the data contains at least a name of the data so selected as to be stored in the removable second storage medium, a date and time when the data is stored in the removable second storage medium, and information for specifying the second storage medium.

20. The method according to claim 15, wherein in the storage control step, data to be stored in the removable second storage medium is selected in accordance with a predetermined data selection condition, and
the data selection condition includes one of conditions: data saved on the oldest date and time among saved data stored in the first storage medium, data of the largest capacity among the saved data, data saved on the oldest date and time among the saved data for each user who designates save, and data of the largest capacity among the saved data for each user who designates save.

21. The method according to claim 16, wherein in the storage control step, information about a function necessary to process the data so selected as to be stored in the removable second storage medium is stored in the removable second storage medium, and
in the print control step, information about a function capable of processing the selected data is printed on the print medium.

22. The method according to claim 21, wherein the information about the function contains at least one of option information, a model, and a specific ID of an apparatus.

23. The method according to claim 21, further comprising a determination step of determining whether a function of the image processing apparatus can process the selected data, by comparing the information, read from the removable second storage medium, about the function necessary to process the selected data with the information about the function which is provided by the image processing apparatus and can process the data.

24. The method according to claim 23, further comprising a read step of reading out the selected data from the removable second storage medium when the function of the image processing apparatus is determined in the determination step to be able to process the selected data,
the read step includes:
a step of determining, from the information on the function read out from the removable second storage medium, whether the selected data is stored in the removable second storage medium by another information processing apparatus,
a step of, when the selected data is determined to be stored in the removable second storage medium by said other information processing apparatus, inquiring of a user whether to read out the selected data from the removable second storage medium and process the selected data, and
a step of reading out the selected data from the removable second storage medium in response to a permission input from the user.

25. The method according to claim 15, wherein the first storage medium includes a storage medium which is arranged in the image processing apparatus having a print function and saves print data, and
the second storage medium includes a storage medium removable from an external removable medium control unit of the image processing apparatus having the print function.

26. An image processing method comprising:
a determination step of determining whether a function of an image processing apparatus can process selected data, by comparing information about a function which is provided by the image processing apparatus and can process data, with information about a function necessary to process the selected data that is read from a removable second storage medium storing the selected data and the information about the function; and
a processing step of, when the function of the image processing apparatus is determined in the determination step to be able to process the selected data, processing the selected data read out from the removable second storage medium.

27. The method according to claim 26, further comprising a read step of reading out the selected data from the removable second storage medium when the function of the image processing apparatus is determined in the determination step to be able to process the selected data,
the read step includes:
a step of determining, from the information on the function read out from the removable second storage medium, whether the selected data is stored in the removable second storage medium by another information processing apparatus,
a step of, when the selected data is determined to be stored in the removable second storage medium by said other information processing apparatus, inquiring of a user whether to read out the selected data from the removable second storage medium and process the selected data, and
a step of reading out the selected data from the removable second storage medium in response to a permission input from the user.

28. An image processing method for an image processing apparatus having a first storage medium which saves data transmitted from an external apparatus, said image processing method comprising:
an instruction input step of designating and inputting data to be stored in a removable second storage medium in accordance with an instruction from a user;
a storage control step of leaving, in the first storage medium, identifiable information capable of identifying data designated in the instruction input step, and deleting the designated data from the first storage medium;
a display control step of displaying a selection window containing the identifiable information so as to accept selection of data to be printed;
a selection step of selecting the data to be printed that is designated via the selection window displayed in the display control step;
a notification step of notifying the user to mount the removable second storage medium when the data to be printed that is selected in the selection step is stored in the removable second storage medium in the storage control step; and
a print control step of controlling to print the data to be printed that is selected in the selection step according to mounting the removable second storage medium notified in the notification step.

29. A storage medium storing, in a computer-readable form, a program that realizes an image processing method for an image processing apparatus having a first storage medium which saves data transmitted from an external apparatus, wherein said program causes a computer to execute:
a monitor step of monitoring a free capacity of the first storage medium,
a storage control step of, when no new data is determined in the monitor step to be saved, storing selected data in a removable second storage medium, leaving, in the first storage medium, identifiable information capable of identifying the selected data, and deleting the selected data from the first storage medium,
a display control step of displaying a selection window containing the identifiable information so as to accept selection of data to be printed,
a selection step of selecting the data to be printed that is designated via the selection window displayed in the display control step,
a notification step of notifying a user to mount the removable second storage medium when the data to be printed that is selected in the selection step is stored in the removable second storage medium in the storage control step, and
a print control step of controlling to print the data to be printed that is selected in the selection step according to mounting the removable second storage medium notified in the notification step.

30. A storage medium storing, in a computer-readable form, a program that realizes an image processing method, wherein said program causes a computer to execute:
a determination step of determining whether a function of an image processing apparatus can process selected data, by comparing information on a function which is provided by the image processing apparatus and can process data, with information on a function necessary to process the selected data that is read from a removable second storage medium storing the selected data and the information on the function, and
a processing step of, when the function of the image processing apparatus is determined in the determination step to be able to process the selected data, processing the selected data read out from the removable second storage medium.

31. A storage medium storing, in a computer-readable form, a program that realizes an image processing method for an image processing apparatus having a first storage medium which saves data transmitted from an external apparatus, wherein said program causes a computer to execute:
an instruction input step of designating and inputting data to be stored in a removable second storage medium in accordance with an instruction from a user,
a storage control step of leaving, in the first storage medium, identifiable information capable of identifying data designated in the instruction input step, and deleting the designated data from the first storage medium,
a display control step of displaying a selection window containing the identifiable information so as to accept selection of data to be printed,
a selection step of selecting the data to be printed that is designated via the selection window displayed in the display control step,
a notification step of notifying the user to mount the removable second storage medium when the data to be printed that is selected in the selection step is stored in the removable second storage medium in the storage control step, and
a print control step of controlling to print the data to be printed that is selected in the selection step according to mounting the removable second storage medium notified in the notification step.
